(19) United States
(12) Patent Application Publication
(10) Pub. No.: US 2024/0297316 A1
(43) Pub. Date: Sep. 5, 2024

(54) HYDROGEN IMPURITY TESTING SYSTEM AND HYDROGEN IMPURITY TESTING METHOD

(71) Applicant: HITACHI HIGH-TECH SCIENCE CORPORATION, Tokyo (JP)

(72) Inventors: Yoshitaka SASAGO, Tokyo (JP); Daisuke RYUZAKI, Tokyo (JP); Naoki SUZUKI, Tokyo (JP); Toshiyuki TAKAHARA, Tokyo (JP); Yoshiki MATOBA, Tokyo (JP)

(21) Appl. No.: 18/584,812

(22) Filed: Feb. 22, 2024

(30) Foreign Application Priority Data
Mar. 3, 2023 (JP) 2023-32479

(51) Int. Cl. H01M 8/0444; G01N 27/00

(52) U.S. Cl. CPC H01M 8/0444; G01N 27/002

(57) ABSTRACT

The highly reliable hydrogen impurity testing system includes a sensor unit installed in an atmosphere with highly concentrated hydrogen containing toxic impurities, a heater unit capable of heating the sensor unit, and a system controller controlling the sensor unit and the heater unit. The heater unit includes a semiconductor substrate, an impurity layer of a first conductive type, a metal oxide layer, and a metal electrode layer capable of adsorbing toxic impurities being present on the surface of the metal oxide layer. The system controller detects the concentration of the toxic impurities by measuring the change in work function of the metal electrode layer according to the type and concentration of the toxic impurities, and performs a refreshing operation of desorbing the toxic impurities adsorbed on the metal electrode layer by heating the metal electrode layer with the heater unit based on the result of detection.

### CROSS REFERENCE TO RELATED APPLICATION

The present application claims priority to Japan Patent Application No. 2023-32479, filed Mar. 3, 2023, the entire contents of which are incorporated herein for all purposes by this reference.

### BACKGROUND OF THE DISCLOSURE

### Field of the Disclosure

The present invention relates to a hydrogen impurity testing system and a hydrogen impurity testing method for detecting toxic impurities in high concentration of hydrogen.

### 2. DESCRIPTION OF THE RELATED ART

Background technology in this technical field includes Japanese Patent Application Publication No. 2008-243430 (Patent Document 1), Japanese Patent Application Publication No. 2003-028832 (Patent Document 2), Japanese Patent Application Publication No. 11-219717 (Patent Document 3), Japanese Patent Application Publication No. 2018-72146 (Patent Document 4), and Sensors and Actuators B 157 (2011) 329-352 (Non-patent Document 1).

Polymer electrolyte fuel cells (PEFCs) that use hydrogen as fuel are known to be degraded by toxic impurities such as carbon monoxide, hydrogen sulfide, and hydrocarbons contained in the fuel hydrogen. Therefore, it is necessary to measure the concentration of toxic impurities in the hydrogen that fuels the PEFC.

For example, in a hydrogen production plant, it is necessary to measure the concentration of impurities in hydrogen to reduce the concentration of toxic impurities in the hydrogen to be produced below an acceptable level.

In a fuel cell system using a PEFC, when the concentration of impurities in the hydrogen fuel is high, control operations such as stopping the fuel cell system and refreshing the PEFC are required, and these control operations must be performed at appropriate times. For this purpose, it is essential to measure the concentration of impurities in hydrogen.

Patent Document 1 discloses a technology for measuring the concentration of impurities by using a third PEFC with electrodes that are more easily poisoned by toxic impurities than the fuel cell (PEFC) itself as a sensor and placing the third PEFC upstream of the fuel cell (PEFC). Specifically, the technology measures impurity concentration by detecting an output voltage drop that occurs when the performance of the sensor made of PEFCs is deteriorated by toxic impurities.

Patent Document 2 discloses a technology for measuring impurities in hydrogen using a PEFC in a similar manner to the technology disclosed in Patent Document 1. However, in the technology, instead of measuring the output voltage of the PEFC, an external voltage is applied to the PEFC, and the electric current induced by proton conduction is measured. This technology uses the phenomenon that the electric current induced by proton conduction decreases when the hydrogen electrode of the PEFC deteriorates due to impurities in hydrogen.

Patent Document 3 discloses a technology for measuring impurities in hydrogen using a PEFC as a probe. According to the document, when the PEFC probe is deteriorated due to impurities, the deteriorated PEFC probe is refreshed in a manner that air is supplied to the hydrogen electrode of the PEFC probe, the PEFC probe is short-circuited, etc.

Apart from the detection of impurities, there are several detection principles for hydrogen sensors, as described in Non-Patent Document 1. Among them, sensors such as FET, capacitor, and diode types are classified as work function sensors.

Since these types of sensors can be manufactured using semiconductor wafer processing processes, the sensors have the advantages of relatively low cost, small size, and low power consumption compared to other types of sensors.

As disclosed in Patent Document 4, the phenomenon of dissociative adsorption and desorption of hydrogen on the gate electrode determines the work function of the gate electrode, i.e., the change in the threshold voltage of the sensor. As a result, the hydrogen concentration can be estimated from the change in the threshold voltage.

### DOCUMENTS OF RELATED ART

### Patent Documents

[Patent Document 1] Japanese Patent Application Publication No. 2008-243430
[Patent Document 2] Japanese Patent Application Publication No. 2003-028832
[Patent Document 3] Japanese Patent Application Publication No. H11-219717
[Patent Document 4] Japanese Patent Application Publication No. 2018-72146

### Non-Patent Document

[Non-patent Document 1] Sensors and Actuators B 157 (2011) 329-352

### SUMMARY OF THE DISCLOSURE

The following issues remain in the related art disclosed above.

In the methods described in Patent Documents 1-3, a PEFC, which has fundamentally the same configuration as a fuel cell (PEFC) body, is used for the sensor. Therefore, the method of refreshing the sensor degraded by impurities in hydrogen must be the same as the method of refreshing the fuel cell body.

For example, the refreshing may involve a process of heating the sensor to increase the temperature so that the adsorbed toxic impurities can be desorbed. However, such a method has a problem that the temperature that the sensor can withstand is equal to the temperature that the fuel cell (PEFC) body itself can withstand. Therefore, when the sensitivity of the PEFC provided in the sensor to toxic impurities is increased, i.e., the PEFC is designed to be more susceptible to deterioration due to toxic impurities than the FEFC body, the PEFC of the sensor will irreversibly deteriorate before the PEFC body deteriorates and cannot be restored by refreshing.

Therefore, the sensor cannot fulfill its original purpose of measuring the concentration of toxic impurities to protect the PEFC body, resulting in deterioration of the PEFC body and reduction in the life of the PEFC body. To prevent this, the deteriorated sensor must be replaced. The replacement has a problem that the system must be shut down, which increases the cost of replacing the sensor.

The present invention has been made in view of the problems occurring in the related art and is to provide a highly reliable impurity inspection system and method for measuring the concentration of toxic impurities in hydrogen, to inhibit deterioration of a fuel cell system attributable to toxic impurities in hydrogen, and to extend the service life of the fuel cell system.

The present invention adopts the following configuration to solve the aforementioned problems. That is, a hydrogen impurity testing system according to a first invention includes: a sensor unit installed in an atmosphere with highly concentrated hydrogen containing toxic impurities; a heater unit capable of heating the sensor unit; and a system controller that controls at least the sensor unit and the heater unit and measures an electric current that follows when a voltage is applied to the sensor unit. The heater unit includes a semiconductor substrate, an impurity layer of a first conductivity type formed on the surface of the semiconductor substrate, a metal oxide layer formed on the surface of the semiconductor substrate, and a metal electrode layer formed on the metal oxide layer and formed of a metal having adsorption sites for hydrogen and toxic impurities so that toxic impurities can be adsorbed when the metal electrode layer is exposed to the atmosphere. The system controller detects the concentration of the toxic impurities by measuring changes in work function of the metal electrode layer according to the type and concentration of the toxic impurities, and performs, based on the result of detection, a refreshing operation of desorbing the toxic impurities adsorbed on the metal electrode layer by causing the heater unit to heat the metal electrode layer.

In this hydrogen impurity testing system, the system controller detects the concentration of toxic impurities by measuring changes in the work function of the metal electrode layer (i.e., threshold voltage of the sensor unit) according to the type and concentration of the toxic impurities. In addition, on the basis of the result of detection, the system controller performs a refresh in which the metal electrode layer of the sensor unit composed of a semiconductor, a metal, and a metal oxide is heated by the heater unit to desorb the toxic impurities adsorbed on the metal electrode layer. Therefore, the system has high heat resistance against heating temperatures that desorb toxic impurities and can maintain high reliability.

The metal electrode layer has adsorption sites for hydrogen ions and toxic impurities, and the work function changes as the number of hydrogen ions adsorbed on the metal electrode layer increases with increasing hydrogen concentration in the atmosphere.

The concentration of toxic impurities adsorbed on the metal electrode layer increases as the concentration of toxic impurities in the atmosphere increases, and the change in work function decreases as the number of hydrogen ions adsorbed on the metal electrode layer decreases.

In the system of the invention, to reduce the concentration of toxic impurities adsorbed on the metal electrode layer, the heater unit increases the temperature of the metal electrode layer so that the toxic impurities adsorbed on the metal electrode layer can be desorbed, and the change in the work function of the metal electrode layer can be estimated from the electric current flowing in the sensor unit. The concentration of toxic impurities in hydrogen can be determined on the basis of the detected change in the work function of the metal electrode layer.

The sensor unit may be a FET type, capacitor type, diode type, etc. each of which is composed of a semiconductor, a metal, and a metal oxide.

Compared to the first invention, a hydrogen impurity testing system according to a second invention is characterized in that the heater unit can heat the sensor unit using Joule heat generated by applying a voltage to make an electric current flow, and the system controller performs a refreshing operation by controlling the voltage applied to the heater unit on the basis of the results of detection of concentration of the toxic impurities.

In other words, in the hydrogen impurity testing system, the system controller performs a refreshing operation by controlling the voltage applied to the heater unit on the basis of the results of detection of concentration of toxic impurities. Therefore, high detection accuracy can be obtained over a long period of time by the repeated refreshing operations of controlling the voltage applied to the heater unit.

Compared to the second invention, a hydrogen impurity testing system according to a third invention is characterized in that the system controller, when performing the refresh, has a function of increasing temperature of the sensor unit in stepwise to separate the toxic impurities from correspondence relationship between temperatures of the sensor unit and the amounts of refresh of change in the work function by the toxic impurities.

In other words, in the hydrogen impurity testing system, at the time of performing the refreshing operation, since the system controller can increase the temperature of the sensor unit in stepwise and separate the toxic impurities from correspondence relationship between the temperatures of the sensor unit and the amounts of refresh of change in the work function by the toxic impurities, even though multiple types of toxic impurities are adsorbed, it is possible to separately desorb the toxic impurities and determine the concentration of each of the toxic impurities.

Compared to the second or third invention, a hydrogen impurity testing system according to a fourth invention is characterized in that the system further includes a gas exchange mechanism capable of temporarily introducing air containing oxygen into the atmosphere, in which the system controller has a function of controlling the gas exchange mechanism to supply air to the metal electrode layer.

In other words, in the hydrogen impurity testing system, since the system controller has a function of controlling the gas exchange mechanism to supply air to the metal electrode layer, the refreshing operation can be performed by reacting the oxygen contained in the air with the toxic impurities adsorbed on the metal electrode layer.

Compared to the fourth invention a hydrogen impurity testing system according to a fifth invention is characterized in that when controlling the gas exchange mechanism, the system controller has a function of increasing the concentration of oxygen in the air supplied to the metal electrode layer in stepwise and of separating the toxic impurities from correspondence relationship between the concentration of oxygen and the amounts of refresh of change in work function by the toxic impurities.

In other words, in the hydrogen impurity testing system, when controlling the gas exchange mechanism, since the system controller increases the concentration of oxygen in the air supplied to the metal electrode layer in stepwise and separates the toxic impurities from correspondence relationship between the concentration of oxygen and the amounts of refresh of change in the work function by the toxic impurities, even though multiple types of toxic impurities are adsorbed, the toxic impurities can be separately desorbed, and each of the toxic impurities can be detected.

Compared to the first or second invention, a hydrogen impurity testing system according to a sixth invention is characterized in that the highly concentrated hydrogen is hydrogen supplied to a polymer electrolyte fuel cell. In addition, the system controller has a refresh count recording function that records a refresh count of performed refreshes of the sensor unit, a threshold count determination function of determining whether the refresh count exceeds a predetermined threshold count value, and a fuel cell refreshing function of desorbing the toxic impurities adsorbed to a polymer electrolyte fuel cell when the threshold count determination function determines that the refresh count exceeds the predetermined threshold count value.

In other words, in this hydrogen impurity testing system, since the system controller has the fuel cell refreshing function of desorbing the toxic impurities adsorbed on the polymer electrolyte fuel cell when the threshold count determination function determines that the refresh count exceeds the predetermined threshold count value, the polymer electrolyte fuel cell can be refreshed according to the number of times the sensor unit is refreshed, and thus the service life of the polymer electrolyte fuel cell can be increased.

A seventh invention is a method of testing hydrogen for impurities using the hydrogen impurity testing system of the first invention, the method including: a work function change measurement step of measuring change in the work function of the metal electrode layer; a concentration measurement step of measuring the concentration of a toxic impurity; a threshold determination step of determining whether change in the work function of the metal electrode layer exceeds a predetermined threshold value; and a refresh step of causing the heater unit to heat the sensor unit when it is determined that the change in the work function exceeds the predetermined threshold value in the threshold determination step.

In other words, since the hydrogen impurity testing method includes the threshold determination step of determining whether the change in the work function of the metal electrode layer exceeds the predetermined threshold value and the refresh step of causing the heater unit to heat the sensor unit when it is determined that the change in the work function exceeds the threshold value in the threshold determination step, the sensor unit can be refreshed and maintained in good condition by repeating each of the steps.

A hydrogen impurity testing method according to an eighth invention is characterized in that in the seventh invention, the highly concentrated hydrogen is hydrogen supplied to a polymer electrolyte fuel cell, and the hydrogen impurity testing system performs a refresh count recording step of recording a refresh count of performed refreshes of the sensor unit, a threshold count determination step of determining whether the refresh count exceeds a predetermined threshold count value, and a fuel cell refresh step of desorbing toxic impurities adsorbed on a polymer electrolyte fuel cell when it is determined in the threshold count determination step that the refresh count exceeds the predetermined threshold count value.

In other words, in the hydrogen impurity testing method, since the fuel cell refreshing operation of desorbing the toxic impurities adsorbed on the polymer electrolyte fuel cell is performed when the threshold count value is determined to be exceeded in the threshold count determination step, the polymer electrolyte fuel cell can be refreshed according to the number of times the sensor has been refreshed, and thus the service life of the polymer electrolyte fuel cell can be increased.

In the system and method for testing hydrogen impurities according to the inventions, the system controller detects the concentration of toxic impurities by measuring the change in the work function of the metal electrode layer according to the types and concentrations of the toxic impurities and, based on the results of detection, performs a refreshing operation of causing the heater unit to heat the metal electrode layer of the sensor unit composed of the semiconductor, the metal, and the metal oxide so that the toxic impurities can be desorbed. Therefore, high heat resistance against the heating temperature to desorb the toxic impurities can be provided, and high reliability can be maintained.

Therefore, the hydrogen impurity testing system and method of the inventions enables a compact, low-cost, highly accurate, and long-life system. The system and method of the inventions can be used in conjunction with a polymer electrolyte fuel cell, the service life of the polymer electrolyte fuel cell can be extended.

### BRIEF DESCRIPTION OF THE DRAWINGS

FIG. 1 is a block diagram illustrating an example of a hydrogen impurity testing system as a first embodiment of the present invention.

FIG. 2 is a schematic cross-sectional view of a sensor FET and a reference FET, which are components of the hydrogen impurity testing system in the first embodiment.

FIG. 3 is a circuit diagram illustrating an example of a method of feeding power to the sensor FET, reference FET, and heater in the first embodiment.

FIG. 4 is a view illustrating an example of drain current-gate voltage characteristics of the sensor FET and reference FET in the first embodiment.

FIG. 5 is an explanatory view for description of the dissociative adsorption of molecular hydrogen to a gate electrode of the sensor FET and the diffusion of hydrogen ions into a metal oxide layer in the first embodiment.

FIG. 6 is a view for description of the relationship between the adsorption site occupancy e of the gate electrode of the sensor FET and the threshold voltage shift ΔVg in the first embodiment.

FIG. 7 is a graph for description of the relationship between a hydrogen concentration X in an atmosphere and the threshold voltage shift ΔVg of the sensor FET in the first embodiment.

FIG. 8 is a view for description of a state in which toxic gas (carbon monoxide) occupies the adsorption sites of the gate electrode of the sensor FET in the first embodiment.

FIG. 9 is a graph for description of the relationship between the concentration of toxic gas Y in the atmosphere and the threshold voltage shift ΔVg when the sensor FET is exposed to highly concentrated hydrogen in the first embodiment.

FIG. 10 is a view for comparison in heat resistance temperature between the FET-type gas sensor of the first embodiment and a conventional PEFC sensor.

FIG. 11 is a view illustrating the metal oxide layer material dependence of the threshold voltage shift ΔVg at a predetermined concentration of hydrogen in a sensor FET according to a modification to the first embodiment (the case where the material of the gate electrode layer is platinum).

FIG. 12 is a graph illustrating the substrate material dependence of the temperature dependence of the off-current of the sensor FET and reference FET in the modification to the first embodiment.

FIG. 13 is a circuit diagram illustrating an example of a method of feeding power to the sensor FET, reference FET, and heater in the modification to the first embodiment.

FIG. 14 is a circuit diagram illustrating an example of a method of feeding power to the sensor FET, reference FET, and heater in the modification to the first embodiment.

FIG. 15 is a graph illustrating an example of drain current-gate voltage characteristics of a sensor FET and a reference FET in the modification to the first embodiment.

FIG. 16 is a conceptual cross-sectional view of a sensor capacitor and a reference capacitor in the modification to the embodiment.

FIG. 17 is a circuit diagram illustrating a method of feeding power to the sensor capacitor, reference capacitor, and heater in the modification to the first embodiment.

FIG. 18 is a circuit diagram illustrating an example of a method of feeding power to the sensor capacitor, reference capacitor, and heater in the modification to the first embodiment.

FIG. 19 is a graph illustrating an example of capacitance-gate voltage characteristics of the sensor capacitor and reference capacitor in the modification to the first embodiment.

FIG. 20 is a conceptual cross-sectional view of a sensor diode and a reference diode in a modification to the first embodiment.

FIG. 21 is a circuit diagram illustrating an example of a method of feeding power to the sensor diode, reference diode, and heater in the modification to the first embodiment.

FIG. 22 is a circuit diagram illustrating an example of a method of feeding power to the sensor diode, reference diode, and heater in the modification to the first embodiment.

FIG. 23 is a graph illustrating an example of capacitance-voltage characteristics of the sensor diode and reference diode in the modification to the first embodiment.

FIG. 24 is a block diagram illustrating an example of a hydrogen impurity testing system as a second embodiment of the present invention.

FIG. 25 is a graph illustrating an example of threshold voltage shift ΔVg with time due to toxic gas of the sensor FET and refreshing timing in a highly concentrated hydrogen atmosphere in the second embodiment.

FIG. 26 is a view illustrating an example of a hydrogen impurity testing system including a hydrogen storage tank in the second embodiment.

FIG. 27 is a view illustrating an example of a hydrogen impurity testing system including a PEFC system in the second embodiment.

FIG. 28 is a graph illustrating an example of a sensor device refresh count over time and PEFC refresh timing of the hydrogen impurity testing system of the second embodiment.

FIG. 29 is a graph illustrates an example of a multistep refresh used in the hydrogen impurity testing system in the second embodiment.

FIG. 30 is a graph illustrating an example of ΔVg change with time due to the multistep refresh of the sensor FET in the second embodiment.

FIG. 31 is a graph illustrating an example of a multistep refresh used in the hydrogen impurity testing system in the second embodiment.

FIG. 32 is a flowchart illustrating a hydrogen impurity testing method according to a third embodiment.

FIG. 33 is a flowchart illustrating the hydrogen impurity testing method using multistep refreshing in the third embodiment.

FIG. 34 is a graph illustrating comparison in the life of a PEFC stack between the case where the hydrogen impurity testing method of the third embodiment is used in conjunction with a PEFC system and the case where a conventional hydrogen impurity system using a conventional PEFC sensor device is used in conjunction with a PEFC system.

### DESCRIPTION OF THE PREFERRED EMBODIMENTS

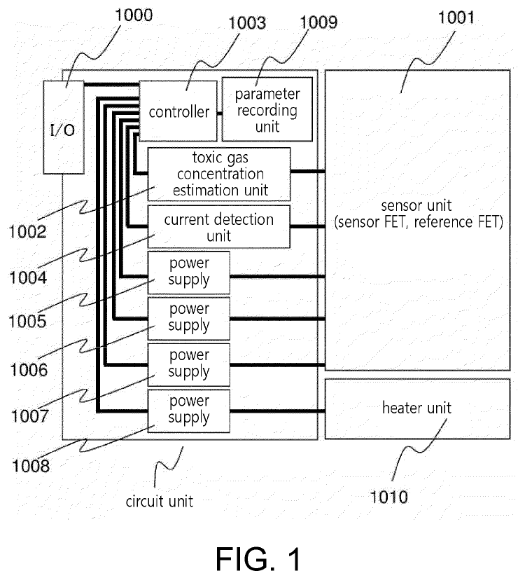

Hereinafter, a hydrogen impurity testing system and a hydrogen impurity testing method according to a first embodiment of the present invention will be described with reference to FIGS. 1 through 23. In the drawings used in the following description, some parts are scaled down as necessary to make the size of each component recognizable or easy to recognize.

### First Embodiment

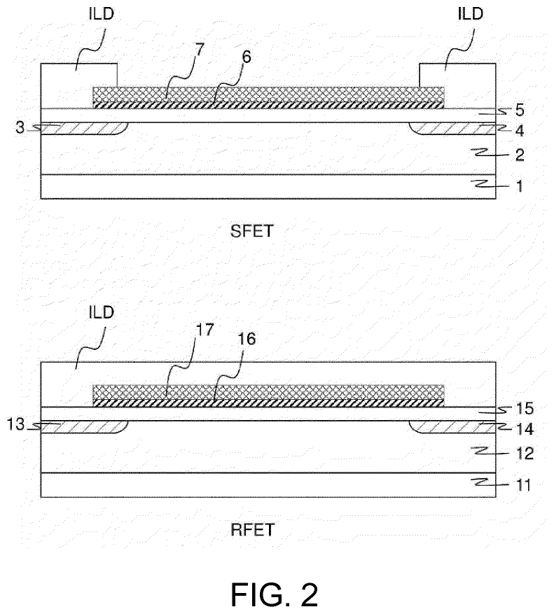

Referring to FIGS. 1 and 2, a hydrogen impurity testing system according to a first embodiment includes a sensor unit 1001 installed in an atmosphere containing toxic impurities in highly concentrated hydrogen, a heater unit 1010 capable of heating the sensor unit, a system controller (also simply called controller 1003) that applies voltage to the sensor unit 1001 to measure an electric current flowing through the sensor unit and controls at least the sensor unit 1001 and heater unit 1010.

The heater unit 1010 includes a semiconductor substrate 1, an impurity layer (well 2) of a first conductivity type formed on the surface of the semiconductor substrate 1, a metal oxide layer (titanium oxide Ti—O layer 6) formed on the surface of the semiconductor substrate 1, and a metal electrode layer (platinum gate layer 7), which is made of a metal having absorption sites for hydrogen and toxic impurities, formed on the metal oxide layer and exposed to the atmosphere to allow toxic impurities to be adsorbed thereon.

The system controller 1003 has a function of detecting the concentration of the toxic impurities by measuring the change in the work function of the metal electrode layer according to the type and concentration of the toxic impurities and of refreshing the metal electrode layer by heating the metal electrode layer based on the detection results. The refreshing refers to desorbing the toxic impurities adsorbed on the metal electrode layer.

The heater unit 1010 can heat the sensor unit 1001 by the temperature increase due to Joule heat generated by applying a voltage to make an electric current flow.

The system controller 1003 has a function of controlling the voltage applied to the heater unit to refresh the system based on the results of detection of concentration of the toxic impurities.

In other words, the hydrogen impurity testing system includes: power supplies 1005 to 1008 that apply voltage to the impurity layer (well 2) of the first conductivity type, the metal electrode layer (platinum gate layer 7), and the heater unit 1010; a current detection unit 1004 that detects the electric current flowing in each of the parts to which the voltage is applied; a toxic gas concentration estimation unit 1002 that estimates the concentration of impurities in hydrogen from the current detection results; and a circuit unit composed of an I/O unit 1000 that transmits and receives data to and from the outside and a controller 1003.

The metal electrode layer (platinum gate layer 7) has adsorption sites for hydrogen ions and toxic impurities, and the work function of the metal electrode layer changes as the number of hydrogen ions adsorbed on the metal electrode layer increases with an increase in the hydrogen concentration in the atmosphere. The amount of toxic impurities adsorbed on the metal electrode layer increases with increase in the concentration of the toxic impurities in the atmosphere, and the change in the work function decreases with decrease in the number of hydrogen ions adsorbed on the metal electrode layer.

The amount of toxic impurities adsorbed on the metal electrode layer (platinum gate layer 7) can be reduced by the increased temperature attributable to the Joule heat generated by the heater unit 1010, and the amount of the work function change can be estimated from the electric current detected by the current detection unit. Therefore, the concentration of the impurities in hydrogen can be detected by the detected work function change.

The circuit unit including the system controller 1003 has a function of detecting the concentration of impurities in hydrogen by detecting the change in the current-voltage characteristic between the impurity layer (well 2) of the first conductivity type and the metal electrode layer (platinum gate layer 7), in which the change in the current-voltage characteristic is attributable to the change in work function of the metal electrode layer.

In addition, the circuit unit has a function of measuring the capacitance between the impurity layer (well 2) of the first conductive type and the metal electrode layer (platinum gate layer 7) by applying a voltage, which is a superposition of DC voltage and AC voltage, across the impurity layer (well 2) of the first conductive type and the metal electrode layer (platinum gate layer 7), and of detecting that the DC voltage dependency of the capacitance changes with the change in work function.

The sensor unit 1001 includes: a first impurity layer of a second conductivity type that serves as a source diffusion layer 3 and which is disposed on the surface of the semiconductor substrate 1; and a second impurity layer of the second conductivity type that serves as a drain diffusion layer 4 and disposed on the surface of the semiconductor substrate 1.

The circuit unit can measure the electric current flowing by controlling the voltage applied to the impurity layer (well 2) of the first conductivity type and the metal electrode layer (platinum gate layer 7) as well as the voltage applied to the first impurity layer of the second conductivity type serving as the source diffusion layer 3 and the second impurity layer of the second conductivity type serving as the drain diffusion layer 4.

The circuit unit applies a ground potential to the impurity layer (well 2) of the first conductivity type and a specific potential across the first impurity layer of the second conductivity type that serves as the source diffusion layer 3 and the second impurity layer of the second conductivity type that serves as the drain diffusion layer 4, and measures the electric current flowing therebetween.

In other words, the circuit unit detects the concentration of impurities in hydrogen by detecting the dependence of the electric current on the potential of the metal electrode layer (platinum gate layer 7) on the change in the work function of the metal electrode layer.

Examples of the material of the metal electrode layer includes precious metals.

Examples of the material of the metal oxide layer includes at least one of titanium, nickel, cobalt, tungsten, aluminum, cerium, zirconium, and silicon.

The first embodiment of the hydrogen impurity testing method is a method for testing impurities in hydrogen using the above-described impurity testing system, and the method includes: a work function change measurement step of measuring change in the work function of the metal electrode layer; a concentration measurement step of measuring the concentration of a toxic impurity; a threshold determination step of determining whether the change in the work function of the metal electrode layer exceeds a predetermined threshold value; and a refresh step of heating the sensor unit with the heater unit when the change in the work function of the metal electrode layer exceeds the predetermined threshold value in the threshold determination step.

### First Embodiment: Configuration of Sensor Unit

The hydrogen impurity testing system and method according to the first embodiment will be described in greater detail below.

FIG. 1 illustrates an example of the hydrogen impurity testing system according to the first embodiment of the present invention. Referring to FIG. 1, the configuration of the hydrogen impurity testing system of the present embodiment includes: a sensor unit 1001 including a sensor FET whose threshold voltage varies depending on the occupancy of hydrogen ions at the adsorption sites of the gate electrode, which varies depending on the hydrogen concentration and the concentration of the toxic impurity gas in the atmosphere, and a reference FET whose threshold voltage is independent of the gas concentration in the atmosphere; a heater unit 1010 that can heat the sensor unit; a toxic gas concentration estimation unit 1002 that estimates the concentration of toxic impurity gas in hydrogen from a signal output from the sensor unit 1001; a current detection unit 1004; power supplies 1005 to 1007 that apply voltages to the sensor unit 1001 including the sensor FET and the reference FET; a power supply 1008 that applies a voltage to heater unit 1010; a controller 1003 that controls the power supplies 1005 to 1008, and an I/O unit 1000 that inputs and outputs information and power between controller 1003 and an external component.

The heater unit 1010 is a heater layer with heating wire HL, which is a wiring made of metal such as aluminum, tungsten, platinum, etc. The heating wire HL can raise the temperature of the sensor unit 1011 using the Joule heat generated when the power supply 1008 feeds power to apply an electric current to the heating wire HL.

The temperature of the sensor unit 1001 can be estimated by measuring the resistance between the two ends of the heating wire HL.

The current detection unit 1004 measures the electric current flowing in the sensor FET and reference FET as described below.

A parameter recording 1009 can record, for example, the voltage conditions applied to the sensor FET, reference FET, and heating wire HL.

FIG. 2 is a cross-sectional view of the sensor FET (SFET) and the reference FET (RFET).

The sensor FET includes a semiconductor substrate 1, a well 2, a source diffusion layer 3, a drain diffusion layer 4, a gate insulating film 5, a titanium oxide Ti—O layer 6 as a sensing material, and a platinum gate layer 7. The surface of gate layer 7 is exposed to the gas atmosphere to be detected.

For example, silicon or silicon carbide (SiC) can be used as the semiconductor substrate 1. The use of platinum-titanium-oxygen as the sensing material to detect a hydrogen concentration is disclosed in Patent Document 4.

The reference FET includes a semiconductor substrate 11, a well 12, a source diffusion layer 13, a drain diffusion layer 14, a gate insulating film 15, a titanium oxide Ti—O layer 16 as a sensing material, and a platinum gate layer 17. The gate layer 17 is isolated from the gas atmosphere to be detected by an interlayer insulating film ILD covering a surface of the gate layer 17.

The wells 2 and 12, the source diffusion layers 3 and 13, the drain diffusion layers 4 and 14, and the gate layers 7 and 17 are connected to wiring layers made of metals such as aluminum, tungsten, and platinum, which can be powered from the power supplies 1005 to 1007 illustrated in FIG. 1.

Herein below, both of the sensor and the reference FET will be described as N-type FETs, but as described below, both can also be P-type FETs. Alternatively, either one can be a P-type FET and the other can be an N-type FET.

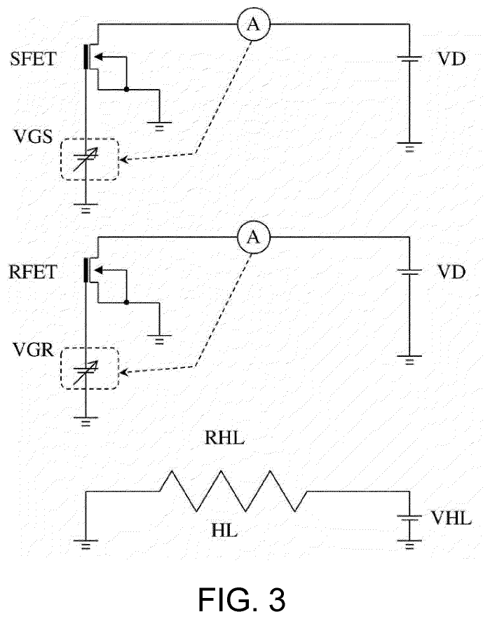

FIG. 3 illustrates one example of operation during detection of concentration of hydrogen, which is the gas to be detected.

An electric current is applied to the heating wire HL, and the Joule heat generated due to the resistance RHL raises the temperature of the sensor unit 1001 to a predetermined temperature. In addition, a voltage VD is applied to the wells 2 and 12, the source diffusion layers 3 and 13, and the drain diffusion layers 4 and 14 of the sensor FET and the reference FET.

A variable voltage VGR is applied to the gate of the reference FET, and a variable voltage VGS is applied to the gate of the sensor FET. The electric current flowing through each of the drain terminals of the sensor and reference FETs is measured by the current detection unit 1008, and the voltages VGS and VGR are controlled by the controller 1003 that the detected electric currents become a predetermined current Ic.

In this case, the difference between VGR and VGS is shown as follows:

$$VGRS = VGR - VGS \qquad ( Equation 1 )$$

The difference between VGRS(0) when the hydrogen concentration in the detection gas atmosphere is 0 and VGRS(X) when the hydrogen concentration is X is defined as follows:

$$Δ Vg ( X ) = VGRS ( 0 ) - VGRS ( X ) \qquad ( Equation 2 )$$

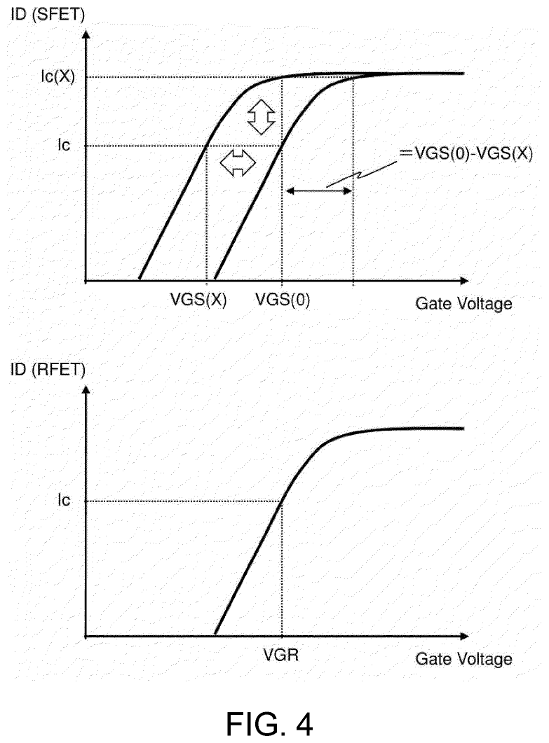

FIG. 4 illustrates the gate voltage-drain current characteristics of the sensor FET and the reference FET.

In the sensor FET, since the gate layer 7, which is a gas sensing material layer, is exposed, the work function of the gate layer 7 changes depending on the detection target gas (toxic impurity), and the gate voltage-drain current characteristic shifts parallel to the voltage direction when the concentration of the detection target gas is 0 or X. As a result, the gate voltage when the threshold current Ic flows changes from VGS(0) to VGS (X).

On the other hand, in the reference FET, the gate voltage-drain current characteristic does not change even though the gas concentration changes because the gate layer 17 is covered by the interlayer insulating film ILD, and the electric current inducted by the application of the voltage VGR to the gate is constantly maintained at Ic. Therefore, ΔVg(X) in Equation 2 corresponds to the change in the threshold value of the sensor FET as a function of the hydrogen concentration X.

Using the VGRS, which is the difference between the gate voltage of the sensor FET and the gate voltage the reference FET, as in Equation 1, the influence of noise due to changes of VGR and VGS caused by temperature fluctuations and other factors can be suppressed by setting the electric current flowing to a drain terminal to an appropriate value as described above.

When the effect of such noise can be sufficiently suppressed, the difference between VGS(0) when the hydrogen concentration in the detection gas atmosphere is 0 and VGS (X) when the hydrogen concentration is X can be used as the threshold change amount ΔVg(X) that varies depending on the hydrogen concentration X, as in Equation 3 below, without using the reference FET.

$$Δ Vg ( X ) = VGS ( 0 ) - VGS ( X ) \qquad ( Equation 3 )$$

In FIGS. 3 and 4, the electric current is measured at the drain terminal. Alternatively, it is also possible to determine ΔVg by measuring the electric current at the source terminal, as described below.

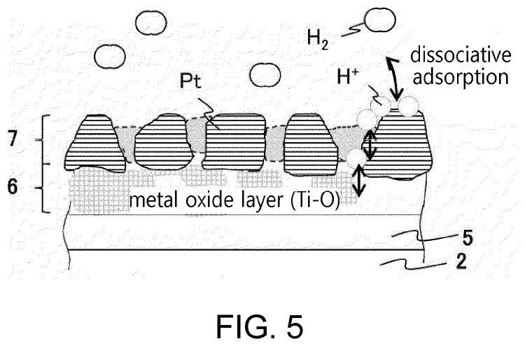

FIG. 5 illustrates the reaction that occurs when the gate electrode of the sensor FET is exposed to an atmosphere containing hydrogen.

When hydrogen molecules in the atmosphere reach the surface of the platinum (Pt) gate layer 7, the hydrogen molecules are dissociatively adsorbed to adsorption sites with a certain probability, become hydrogen ions, and occupy the adsorption sites on the Pt surface. Some of the hydrogen ions diffuse into the Ti—O layer 6.

The dissociatively adsorbed hydrogen ions are desorbed with a certain probability and released into the atmosphere as molecular hydrogen; some of the hydrogen ions that had diffused into the Ti—O layer reoccupy the adsorption sites on the Pt surface with a certain probability.

These reactions occur repeatedly to achieve an equilibrium state in which hydrogen ions occupy the adsorption sites on the platinum surface, depending on the hydrogen concentration in the atmosphere.

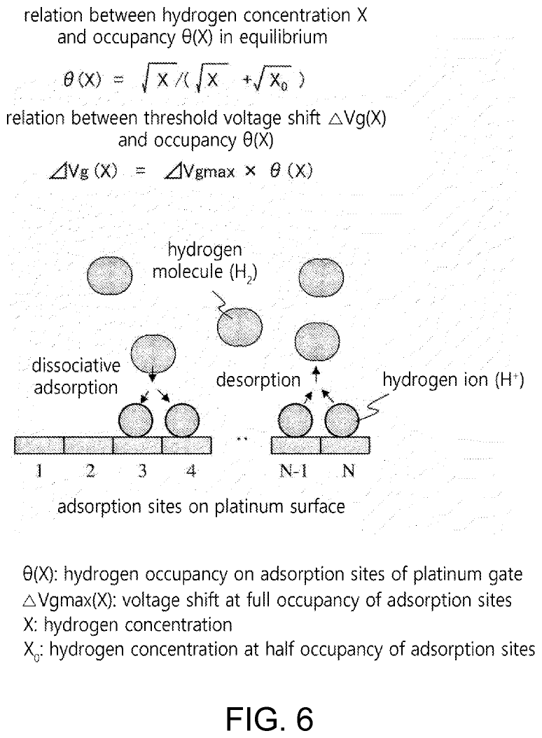

In equilibrium, as shown in FIG. 6, the relationship among the hydrogen concentration in the atmosphere, the adsorption site occupancy e(X) of hydrogen, and the threshold voltage shift ΔVg(X) is as follows:

$$θ ( X ) = {X}^{05} / ( {X}^{05} + {X}_{0}^{05} ) \qquad ( Equation 4 )$$

$$Δ Vg ( X ) = Δ Vgmax \times θ ( X ) \qquad ( Equation 5 )$$

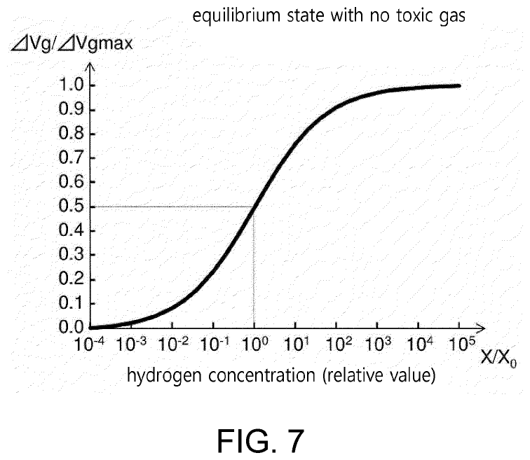

The relationship between the hydrogen concentration X and the threshold voltage shift ΔVg(X) according to Equations 4 and 5 is illustrated in FIG. 7. This is the relationship between ΔVg and the hydrogen concentration X when the FET gas sensor is held in an atmosphere with a hydrogen concentration X for a sufficiently long time to reach the equilibrium state.

The concentration X0 is the hydrogen concentration when a half of the adsorption sites of the platinum gate layer 7 are occupied, and can be changed by the type of the metal oxide layer 6, the structure of the platinum gate layer 7, and the temperature of the sensor unit 1001 controlled by the heating of the heater unit.

For example, suppose the value of X₀ is 10 ppm, then X/X₀=10⁵ in FIG. 7 corresponds to X=1, i.e., a concentration level of 100%.

FIGS. 6 and 7 illustrate the case where no toxic impurities are present in the atmosphere.

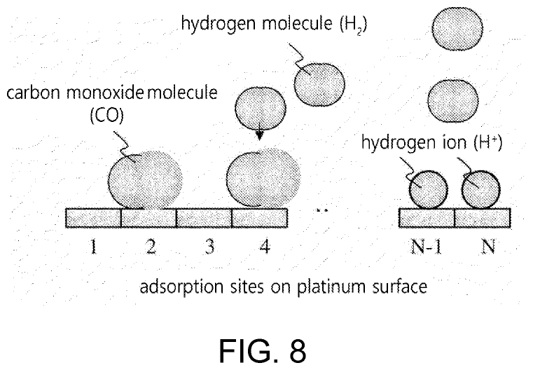

When a toxic impurity, such as carbon monoxide CO, is present in the atmosphere in addition to hydrogen, as shown in FIG. 8, the adsorption sites on the surface of the Pt gate layer 7 are partially occupied by CO, so that hydrogen cannot be dissociatively adsorbed on the occupied adsorption sites. Therefore, even in highly concentrated hydrogen where most of the adsorption sites of the Pt gate layer 7 are occupied by hydrogen ions when no toxic impurity is present, when a toxic impurity CO is present, the percentage of adsorption sites occupied by the hydrogen ions decreases according to the concentration of the toxic impurity CO.

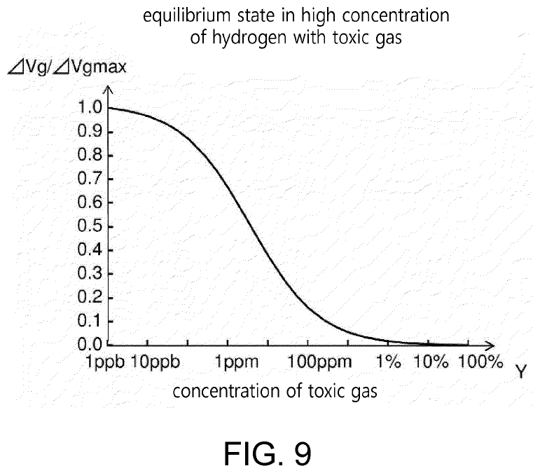

As a result, when the toxic impurity CO is present in the atmosphere, the threshold voltage shift ΔVg decreases with CO concentration in the equilibrium, as shown in FIG. 9.

When the CO concentration changes, the ΔVg approaches the threshold voltage shift for the equilibrium state, over time as shown in FIG. 9.

FIGS. 8 and 9 illustrate the case where the toxic impurity is carbon monoxide CO, but the same is true for other toxic impurities, such as hydrocarbons CH and hydrogen sulfide H₂S.

The impurity concentration at which the ΔVg drops sharply can be controlled by the material of the metal oxide layer 6, the structure of the platinum gate layer 7, or the temperature of the sensor unit 1001.

In the example shown in FIG. 9, the change in ΔVg is large and highly sensitive in the concentration region around 1 ppm.

For example, the material of the metal oxide layer 6, the structure of the platinum gate layer 7, or the temperature of the sensor unit 1001 are controlled so that the value of X₀ becomes 10 ppm.

X/X₀=10⁵ in FIG. 7 corresponds to X=1, that is a concentration level of 100%. In this case, when the hydrogen concentration is high, for example, almost 100%, ΔVg in the absence of toxic impurities varies little with concentration.

For example, ΔVg is almost the same in an atmosphere with a hydrogen concentration of 100% and an atmosphere with a hydrogen concentration of 99.99% and the remaining 0.01% of an inert gas (for example, nitrogen or argon) with which the sensor FET does not react.

In contrast, when 0.01% of toxic impurities and 99.99% of hydrogen are present, the threshold voltage shift ΔVg is significantly lowered (FIG. 9).

In such an environment, the concentration of trace toxic impurities in hydrogen can be detected by measuring ΔVg.

$$Δ Vg ( X , Y ) = VGRS ( 0 , 0 ) - VGRS ( X , Y ) \qquad ( Equation 6 )$$

In situations where the sensor is in equilibrium, the concentration of the toxic impurities can be estimated by detecting the value of ΔVg.

When the sensor is not in equilibrium, the concentration of toxic impurities can be estimated by detecting the value of ΔVg and the variation of ΔVg over time.

In most practical cases, it is important to detect the change of ΔVg over time as well as the value of ΔVg because people want to know the concentration of toxic impurities in most cases without waiting for the sensor to reach an equilibrium state.

The value of ΔVg due to toxic impurities in an equilibrium state and the rate of variation of ΔVg over time in a non-equilibrium state can be controlled by heating the sensor unit 1001 with a heater.

In addition, the heater heating can also be used to desorb toxic impurities and refresh the sensor from its toxic state.

Since ΔVg reaches a value corresponding to the concentration of the toxic impurities in equilibrium, and the concentration of the toxic impurities can be detected, it seems that a refreshing operation is unnecessary. However, for some toxic impurities, such as hydrogen sulfide H₂S, when the poisoning progresses beyond a certain level, irreversible poisoning or permanent poisoning will occur, and the threshold voltage shift ΔVg cannot be detected according to the concentration of the toxic impurities in the atmosphere.

Therefore, the refreshing operation for the sensor FET is important, and the heater heating process is a simple way to perform the refreshing operation.

Permanent poisoning can also occur in a modification to the first embodiment, which is described below, and therefore the refreshing operation is equally important in the modification.

### First Embodiment: Effect

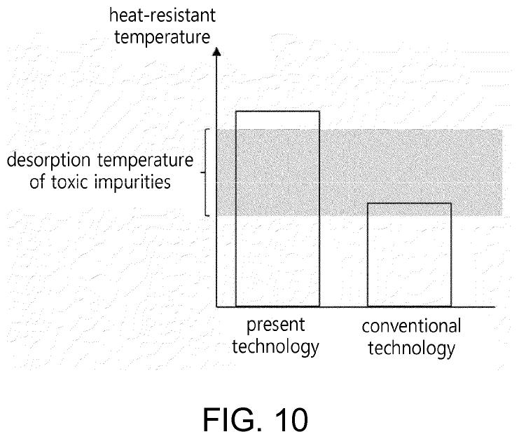

FIG. 10 is a view illustrating comparison between the heat resistance temperature of a FET-type gas sensor, which is a component of the hydrogen impurity testing system as the first embodiment, and that of a conventional PEFC sensor.

When the heat unit heats the sensor FET for the refreshing process, the temperature of the sensor FET needs to be raised to a temperature at which the toxic impurities can be desorbed.

The FET-type gas sensor, which is composed of a silicon substrate, a metal, and a metal oxide, has excellent heat resistance and is specifically heat resistant to the temperature at which most toxic impurities can be desorbed. On the other hand, in the conventional technologies of Patent Documents 1 to 3 in which PEFCs are used for sensors, some toxic impurities can be desorbed by heating, but the sensors cannot be heated to a sufficient temperature at which some the toxic impurities can be desorbed because the PEFCs have insufficient heat resistance.

When using the sensor FET and the reference FET, the electric current only flows to the surface of the semiconductor substrate and do not flow to the metal oxide layers 6 and 16 and the gate layers 7 and 17, which are the gas sensing materials. Therefore, there is no risk that the gas sensing materials will be deteriorated by the electric current.

On the other hand, in the conventional technology using the PEFC sensor to detect impurities based on an electric current, the gas sensing material itself, such as anode, cathode, and electrolyte layer, is subject to electric current flow, which may cause the gas sensing material to deteriorate due to the electric current.

### First Embodiment: Modification

In FIGS. 2 to 10, titanium oxide Ti—O is used for the metal oxide layers 6 and 16 of the sensor and reference FETs, and platinum is used for the gate layers 7 and 17. Alternatively, other materials can be used.

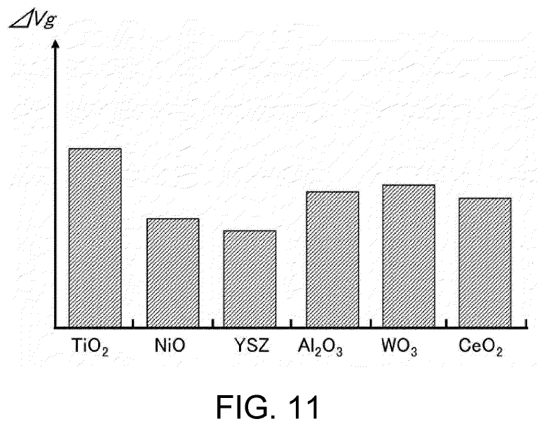

For example, FIG. 11 is a view illustrating comparison in threshold voltage shift ΔVg for the case where titanium dioxide is used for the metal oxide layers 6 and 16 and for the case where other metal oxides are used for the metal oxide layers 6 and 16.

Even in the case where metal oxides other than titanium dioxide are used, the threshold voltage shift ΔVg can be confirmed.

The behavior of ΔVg decreasing due to toxic impurities can also be confirmed in the same way. Since the heat resistance and the impurity concentration region where ΔVg changes with high sensitivity vary depending on the metal oxide used, an appropriate metal oxide can be selected according to the application.

For the gate layers 7 and 17, precious metals other than platinum can be used to detect the concentration of toxic impurities. For example, palladium, rhodium, iridium, etc. can be used.

Although the sensor device can be easily heated above ambient temperature by heating of the heater layer, it is difficult to add the function of cooling. Therefore, the sensor devices must be able to operate at or above the ambient temperature.

When the atmosphere is in the temperature range of from room temperature to about 250° C., a silicon substrate can be used for the semiconductor substrate 1, but at higher temperatures, the sensor FET and reference FET cannot operate because the off-current of the sensor FET and reference FET increases above a determination current Ic.

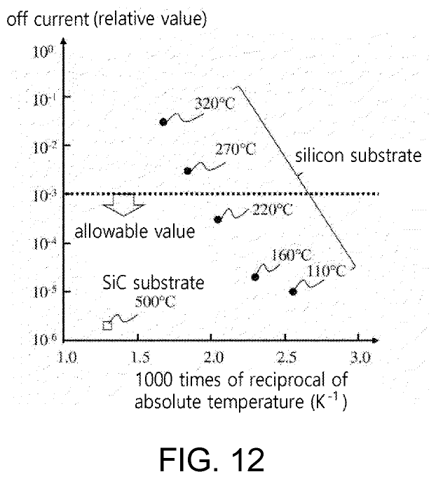

As shown in FIG. 12, the use of a silicon carbide (SiC) substrate instead of a silicon substrate can reduce the off-current at high temperatures and increase the operable temperature to about 500° C. or higher. In other words, although SiC substrates are more expensive than silicon substrates, the FET-type sensors based on the SiC substrate can measure impurity concentrations in hydrogen at high temperatures at which FET-type sensors based on the silicon substrate cannot operate.

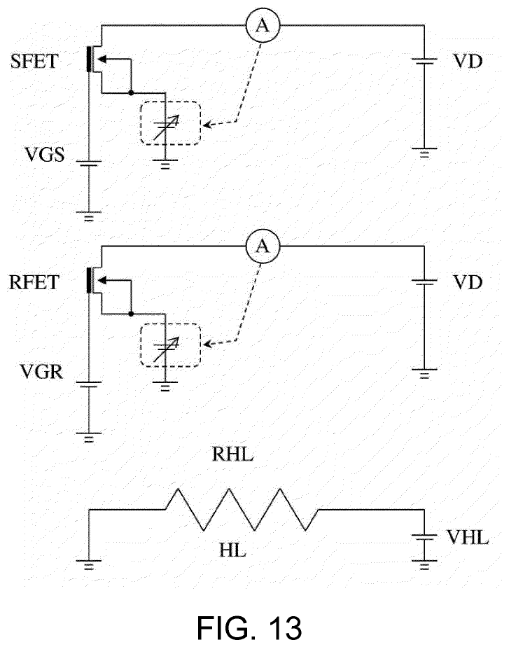

To detect ΔVg, in FIG. 3, the gate voltage is controlled so that the currents of the sensor FET and the reference FET become constant. Alternatively, the source voltage can be controlled to make the currents of the sensor and reference FETs constant as shown in FIG. 13.

The threshold voltage upon application of a substrate bias is as follows:

$${V}_{th} ( {V}_{BS} ) = {V}_{FB} + 2 {φ}_{F} + {[ 2 ε qNA ( 2 {φ}_{F} + \vert {V}_{BS} \vert ) ]}^{0.5} / {C}_{ox} . \qquad ( Equation 7 )$$

To make the current constant at a well voltage of 0 V, the source voltage that is set to 0 V is changed to V_{S}. Then, the threshold voltage shift ΔVg can be calculated as follows:

$$Δ Vg = {[ 2 ε {qN}_{A} ( 2 {φ}_{F} + \vert {V}_{S} \vert ) ]}^{0.5} / {C}_{ox} - {[ 2 ε {qN}_{A} ( 2 {φ}_{F} ) ]}^{0.5} / {C}_{ox} . \qquad ( Equation 8 )$$

V_{FB} is the flat band voltage, 2φ_{F} is the surface potential when the inversion state is entered, E is the dielectric constant of the semiconductor substrate 1, q is the elementary charge, NA is the channel impurity concentration, and Cₒₓ is the gate oxide film capacitance.

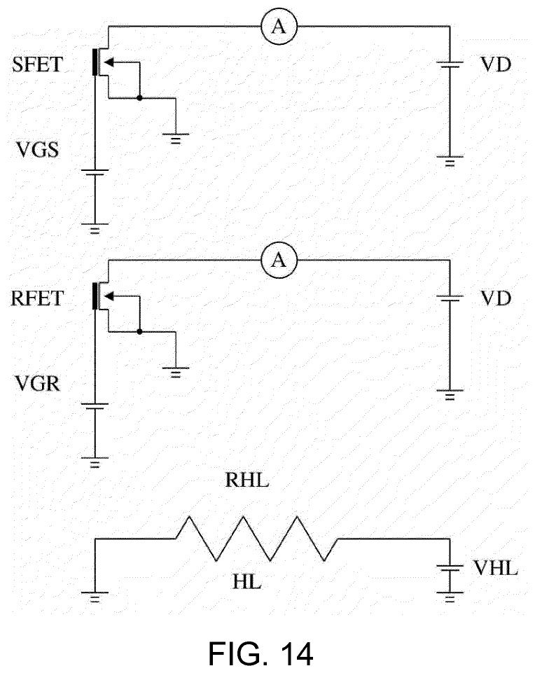

To detect ΔVg, the currents of the sensor and reference FETs are controlled to be constant in FIGS. 3 and 13. Alternatively, as shown in FIG. 14, the applied voltage may be constant, and the varying current may be detected.

When the waveform of the current-voltage characteristic of the sensor FET does not change with gas concentration, as shown in FIG. 4, the threshold voltage shift can be posted by detecting an increase in current value.

When the current increases to the point where the current value does not vary much with the gate voltage, the detection of the threshold voltage shift ΔVg becomes less accurate, but the system control may be easier because the control of the voltage is no longer necessary.

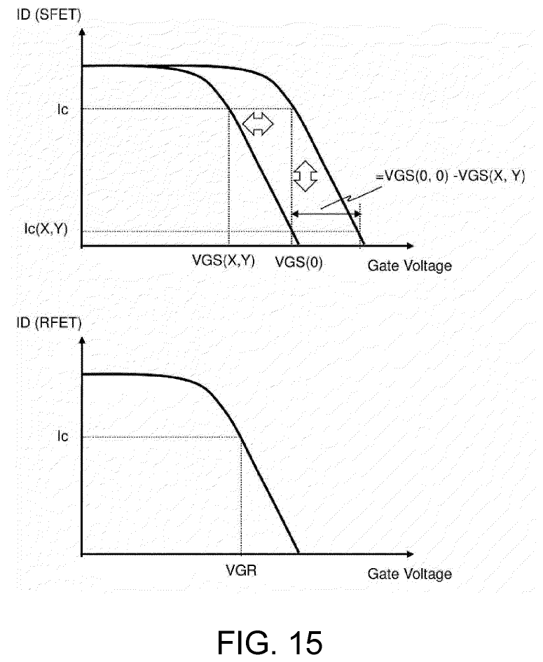

Although FIG. 2 illustrates that the sensor FET and reference FET are N-type FETs, P-type FETs can also be used as the sensor FET and reference FET. As shown in FIG. 15, the threshold voltage shifts toward the negative voltage side according to the hydrogen concentration, as is the case with the N-type FETs. The same is true for the threshold voltage shift which decreases with the concentration of toxic impurities. The same materials can be used for the metal oxide layers 6 and 16 and the gate electrode layers 7 and 17 as in the case of the N-type FETs, and a silicon or SiC substrate can be used as the semiconductor substrate 1.

As in the case of N-type FETs, the threshold voltage shift ΔVg can be detected by the control shown in FIGS. 3, 13, and 14. The voltage applied to the gate is different between the case of an N-type PET and a P-type PET when the FET is turned on and the current Ic flows. Depending on the materials used for the metal oxide layers 6 and 16 and the gate electrode layers 7 and 17 and on the operating temperature, either N-type FETs or P-type FETs are more advantageous in terms of the reliability of the sensor and reference FETs. The one that can ensure higher reliability can be selected depending on the application.

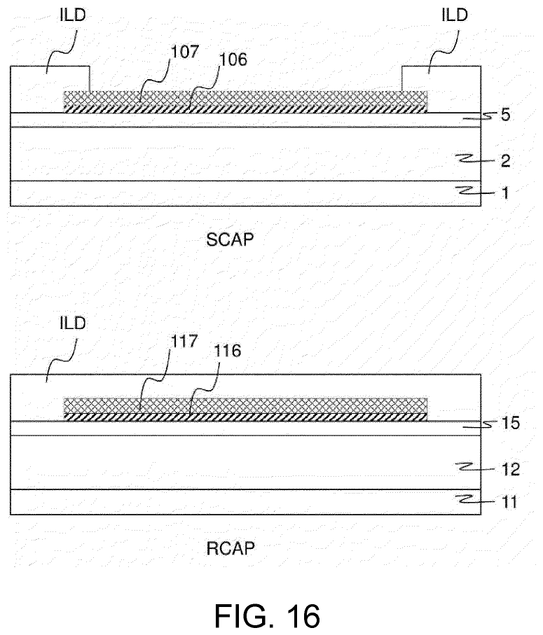

In the example of FIGS. 1 to 15, a sensor FET and a reference FET are employed in the sensor unit 1001. However, instead of the sensor and reference FETs, a sensor capacitor and a reference capacitor can be used as shown in FIG. 16.

FIG. 16 is a cross-sectional view of a sensor capacitor (SCAP) and a reference capacitor (RCAP).

The sensor capacitor is composed of a semiconductor substrate 1, a well 2, a gate insulating film 5, a metal oxide layer 106 that serves as a sensing material, and a gate layer 107 that contains a precious metal. The surface of the gate layer 107 is exposed to a gas atmosphere to be detected.

For example, silicon or silicon carbide (SiC) can be used for the semiconductor substrate 1.

The reference capacitor is composed of a semiconductor substrate 11, a well 12, a gate insulating film 15, a metal oxide layer 116 that serves as a sensing material, and a gate layer 117 that contains a precious metal. The surface of the gate layer 117 is covered with an interlayer insulating film ILD so as to be isolated from the gas atmosphere to be detected.

The wells 2 and 12 and the gate layers 107 and 117 are connected to wiring layers made of a metal such as aluminum, tungsten, and platinum, so that the wells 2 and 12 and the gate layers 107 and 117 can be powered by the power supplies 1005 to 1007 illustrated in FIG. 1.

Herein below, both the sensor and reference capacitors are described as using N-type wells 2 and 12. However, the capacitors may use P-type wells. Alternatively, either one of the capacitors may use a P-type well and the other may use an N-type well.

In the case of using a sensor capacitor and a reference capacitor, the structure of the sensor unit 1001 is simplified compared to the case of using a sensor FET and a reference FET because a source-drain diffusion layer is not necessary. On the other hand, as described below, it is necessary to measure the capacitance based on an AC voltage, which is not necessary in the case of using a sensor FET and a reference FET.

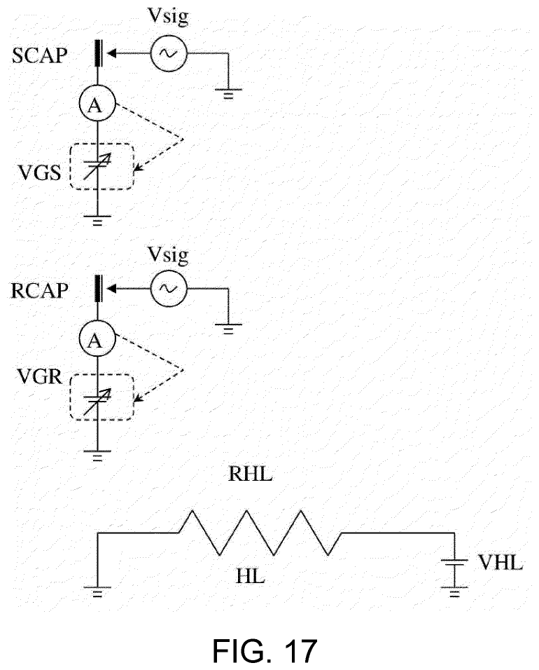

FIG. 17 illustrates one exemplary operation of the sensor capacitor and reference capacitor.

The sensor capacitor and reference capacitor are heated to a predetermined temperature by the Joule heat generated due to the resistance RHL when an electric current flows through the heating wire HL.

A voltage of 0 V is applied to the wells 2 and 12 of the sensor and reference capacitors.

A variable voltage VGR is applied to the gate of the reference capacitor and a variable voltage VGS is applied to the gate of the sensor capacitor. In addition to the application of the DC voltages VGR and VGS, an AC voltage with an amplitude of Vsig is applied to the terminals of the wells 2 and 12.

The capacitance C (SCAP) of the sensor capacitor and the capacitance C (RCAP) of the reference capacitor can be detected by measuring the alternating current flowing through of the gate terminal of the sensor capacitor and the gate terminal of the reference capacitor, with the current detection unit 1004. The VGS and VGR are controlled by the controller 1003 so that both capacitances match a constant capacitance C0.

The difference VGRS between VGR and VGS is calculated by Equation 1.

The threshold voltage shift is the value obtained by subtracting the VGRS for the case where the atmosphere contains hydrogen at a concentration of X and toxic impurities at a concentration of Y from the VGRS for the case where the atmosphere is free of hydrogen and toxic impurities. In the case of an atmosphere in which the hydrogen concentration in the atmosphere is almost 100% and contains trace toxic impurities, the concentration of the toxic impurities can be estimated by detecting ΔVg.

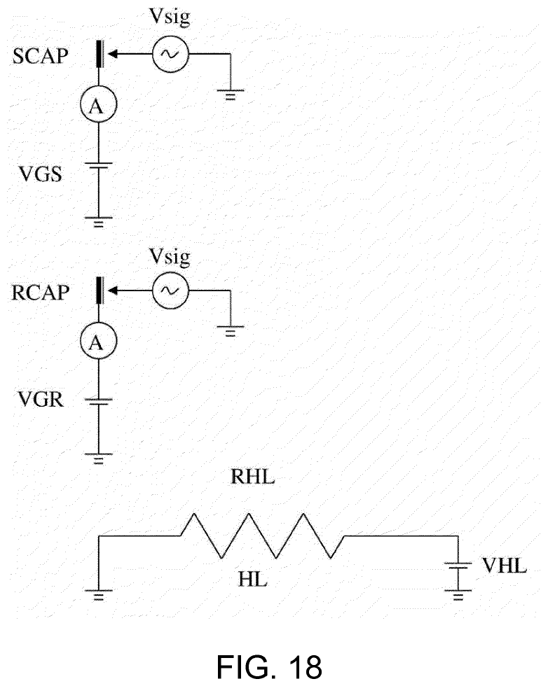

In FIG. 17, the gate voltage is controlled so that the capacitance of the sensor capacitor and the capacitance of the reference capacitor have each a constant value C0. However, as shown in FIG. 18, the gate voltages VGR and VGS are maintained at constant values, and ΔVg can be detected by measuring the change in capacitance.

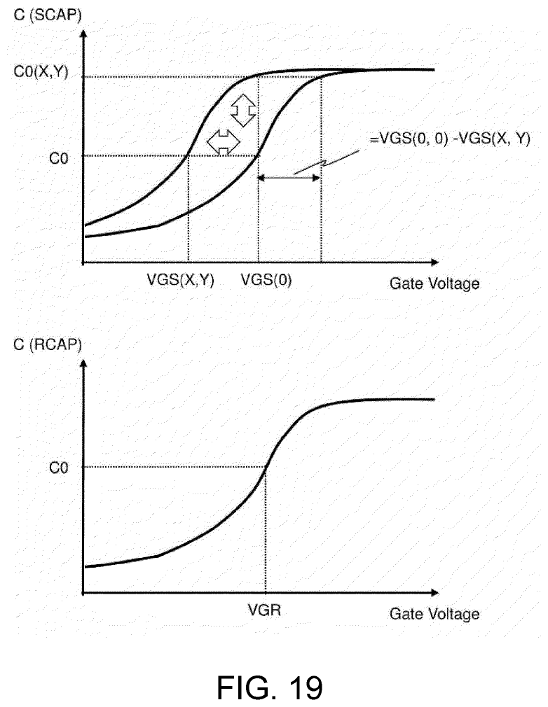

When the waveforms of the capacitance-voltage characteristics of the sensor and reference capacitors do not change with change in the gas concentration in the atmosphere, the threshold voltage shift can be estimated from the change in capacitance of the sensor capacitor, which depends on the gas concentration (FIG. 19).

FIG. 19 illustrates the capacitance-gate voltage characteristics of the sensor and reference capacitors.

Since the gate layer 106 of the sensor capacitor is exposed, the threshold voltage varies with the toxic impurity concentration Y. Therefore, the gate voltage at which the capacitance value is C0 changes from VGS (100%, 0) to VGS (100%-Y, Y).

On the other hand, in the reference capacitor, since the gate layer 116 is covered with the interlayer insulating film ILD, the capacitance-gate voltage characteristic does not change even though the concentration of toxic impurities changes, and the capacitance value remains constant at C0 when the voltage VGR is applied to the gate.

Therefore, ΔVg(X,Y) in Equation 6 corresponds to the threshold voltage shift of the sensor capacitor for the toxic impurity concentration Y. Therefore, in the case of using the sensor capacitor and the reference capacitor, the concentration of toxic impurities in hydrogen can be estimated from ΔVg and its variation over time in the same way as in the case of using the sensor FET and the reference FET.

The refreshing by heater heating can be performed in the same way.

Since the materials used are semiconductor substrates and metal oxides, and the sensor capacitor and reference capacitor are superior in heat resistance compared to the conventional sensors using PEFCs as shown in FIG. 10 and are thus advantageous when performing the refreshing operation.

For the metal oxide layers 106 and 116, aside from titanium dioxide as shown in FIG. 11, several other materials can be selected. For the gate electrode layers 107 and 117, precious metals such as palladium, rhodium, and iridium can be used aside from platinum.

In addition to silicon substrates, SiC substrates can be used for the semiconductor substrate 1, which is more expensive than silicon substrates but allows detection of toxic impurity concentrations at higher temperatures.

When using a sensor capacitor and a reference capacitor, the electric current only flows to the surface of the semiconductor substrate but does not flow to the metal oxide layers 106 and 116 and gate layers 107 and 117, which are the gas sensing material. Therefore, there is no risk of deterioration of the gas sensing material attributable to the electric current. On the other hand, in the conventional technology using PEFC sensor elements, when impurities are detected on the basis of electric current, since electric current flows through the gas sensing materials themselves, such as the anode, cathode, and electrolyte layers, there is a risk that the gas sensing materials will be deteriorated by the electric current.

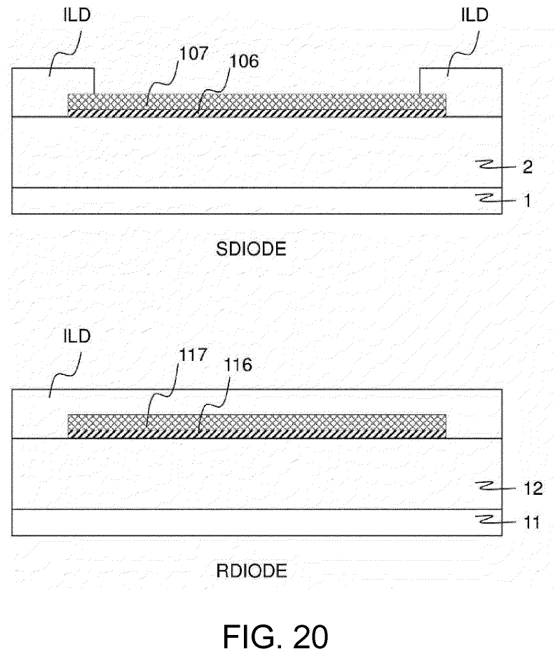

FIGS. 1 to 15 illustrate the sensor unit 1001 using the sensor FET and the reference FET, and FIGS. 16 to 19 illustrate the sensor unit 1001 using the sensor capacitor and the reference capacitor. However, instead of these arrangements, a sensor diode and a reference diode can be used as shown in FIG. 20.

FIG. 20 is a cross-sectional view of a sensor diode (SDIODE) and a reference diode (RDIODE).

The sensor diode is composed of a semiconductor substrate 1, a well 2, a metal oxide layer 106 that serves as a sensing material, and a gate layer 107 containing a precious metal. The surface of the gate layer 107 is exposed to the atmosphere of gas to be detected.

For example, silicon or silicon carbide (SiC) can be used for the semiconductor substrate 1. The reference diode is composed of a semiconductor substrate 11, a well 12, a metal oxide layer 116 serving as a sensing material, and a gate layer 117 containing a precious metal. Since the surface of the gate layer 117 is covered with an interlayer insulating film ILD, the surface of the gate layer 117 is isolated from the atmosphere of gas to be detected.

The wells 2 and 12 and gate layers 107 and 117 are connected to wiring layers made of a metal such as aluminum, tungsten, or platinum and can be powered by the power supplies 1005 to 1007 illustrated in FIG. 1. In the following description, both the sensor and reference diodes are described as using N-type wells 2 and 12, but P-type wells can also be used.

Alternatively, either one of the sensor and reference diodes may use a P-type well and the other diode may use an N-type well. The configuration using the sensor diode and the reference diode is simpler in structure than the configuration using the sensor FET and the reference FET.

In addition, the configuration using the sensor diode and the reference diode does not require an AC voltage that is necessarily used by the configuration using the sensor capacitor and the reference capacitor. On the other hand, in the case of using the sensor FET and the reference FET or the case of using the sensor capacitor and the reference capacitor, no DC current flows through the metal oxide layers 6, 16, 106, and 116 and the gate layers 7, 17, 107, and 117, which are used as gas sensing materials. However, in the system using the sensor diode and the reference diode, DC current flows through the metal oxide layers 106 and 116 and the gate layers 107 and 117. Therefore, care must be taken in terms of reliability.

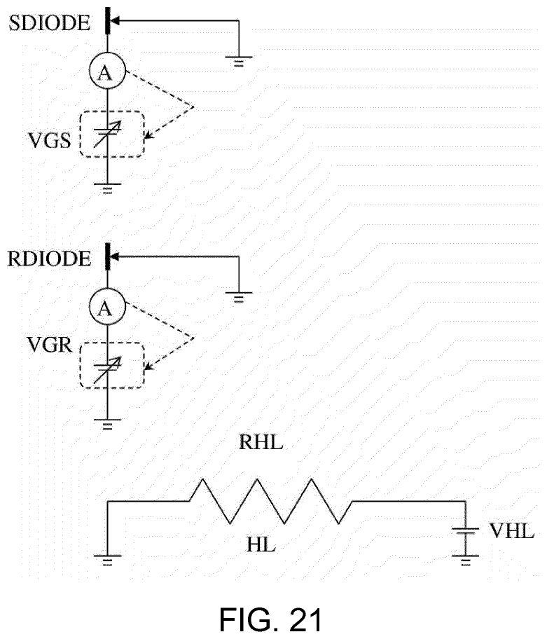

FIG. 21 illustrates one example of the operation of the sensor diode and reference diode.

An electric current is applied to the heating wire HL, and the Joule heat generated due to the resistance RHL raises the sensor diode and reference diode to a specified temperature. A voltage of 0 V is applied to the wells 2 and 12 of the sensor and reference diodes. A variable voltage VGR is applied to the gate of the reference diode, and a variable voltage VGS is applied to the gate of the sensor diode. The electric currents flowing through the respective gate terminals of the sensor and reference diodes are measured by the current detection unit 1004. The VGS and VGR are controlled by the controller 1003 so that the electric currents of both the diodes match a constant IC.

The difference VGRS between VGR and VGS is calculated in the same way as in Equation 1.

The threshold voltage shift is the value obtained by subtracting the VGRS which is the voltage for the case where the atmosphere contains hydrogen at a concentration of X and toxic impurities at a concentration of Y from the VGRS which is the voltage for the case where the atmosphere is free of hydrogen and toxic impurities. In the case of an atmosphere in which the hydrogen concentration in the atmosphere is almost 100% and contains trace toxic impurities, the concentration of the toxic impurities can be estimated by detecting ΔVg.

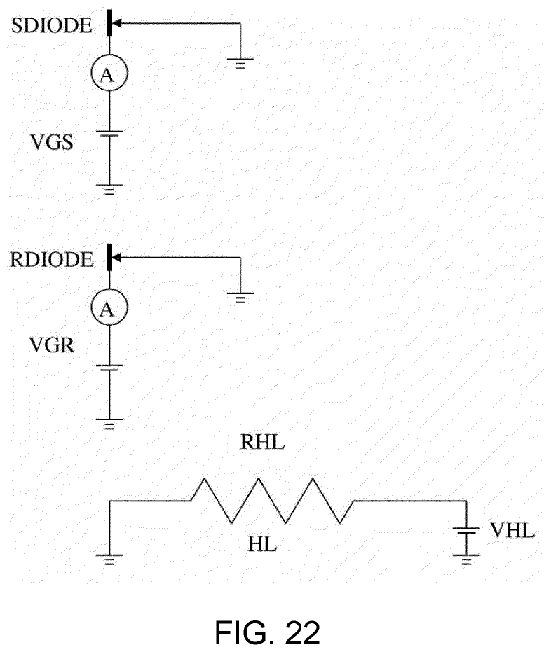

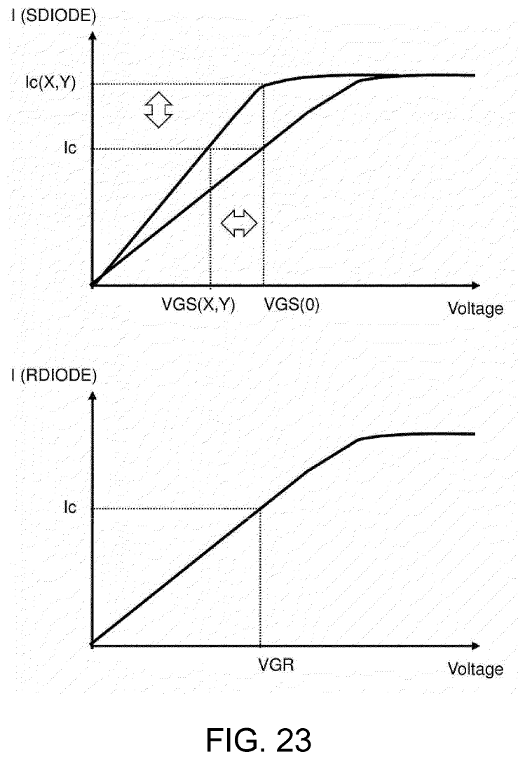

In FIG. 22, the gate voltage was controlled so that the electric currents of the sensor diode and the reference diode have each a constant value IC. However, as shown in FIG. 23, the gate voltages VGR and VGS are maintained at constant values, and ΔVg can be detected by measuring the electric current change.

When the waveform of the current-voltage characteristic between the sensor diode and the reference diode does not change with changes in the gas concentration in the atmosphere, the threshold voltage shift can be estimated from the change in the electric current of the sensor diode according to the gas concentration.

However, since the diode has a characteristic that the electric current is zero when the voltage is zero, it is impossible to prevent the entire waveform from being unchanged by the gas concentration. This is different from the case where FETs or capacitors are used. The method shown in FIG. 22 can be used only when the waveform change is negligible.

FIG. 23 illustrates the current-voltage characteristics of the sensor diode and reference diode.

Since the gate layer 106 of the sensor diode is exposed, the threshold voltage varies with the toxic impurity concentration Y. As a result, the gate voltage at which the current value becomes IC changes from VGS (100%, 0) to VGS (100%-Y, Y).

On the other hand, since the gate layer 116 of the reference diode is covered by the interlayer insulating film ILD, the current-voltage characteristic does not change even though the concentration of toxic impurities changes, and the current value remains constant at IC when the voltage VGR is applied to the gate. As a result, ΔVg (X, Y) in Equation 6 corresponds to the threshold voltage shift of the sensor diode according to the toxic impurity concentration Y. The concentration of toxic impurities in hydrogen can also be estimated from ΔVg and its variation over time when the sensor diode and the reference diode are used.

The Refreshing by heater heating can be performed in the same way.

Since the materials used are a semiconductor substrate and a metal oxide, the embodiment configuration is superior in heat resistance compared to a conventional sensor using a PEFC, as shown in FIG. 10, and is advantageous when a refreshing operation is performed.

For the metal oxide layers 106 and 116, several materials can be selected in addition to titanium dioxide, as shown in FIG. 11. For the gate electrode layers 107 and 117, precious metals such as palladium, rhodium, and iridium can be used in addition to platinum. In addition to silicon substrates, SiC substrates can be used for the semiconductor substrate 1. SiC substrates are more expensive than silicon substrates but enable the detection of toxic impurity concentrations at higher temperatures.

Thus, in the hydrogen impurity testing inspection system of the present embodiment, the system controller 1003 detects the concentration of toxic impurities by measuring changes in the work function of the metal electrode layer (threshold voltage of the sensor unit 1001) according to the type and concentration of the toxic impurities. Based on the results of detection, the gate layer (metal electrode layer) of the sensor unit 1001, which is composed of a semiconductor, a metal, and a metal oxide, is heated by the heater unit 1010 to refresh the gate layer (metal electrode layer). The refreshing refers to desorbing the toxic impurities adsorbed on the gate layer. Therefore, the sensor unit has high heat resistance against the heating temperature at which the toxic impurities can be desorbed and can maintain high reliability.

In addition, since the system controller 1003 performs a refreshing process by controlling the voltage applied to the heater unit 1010 (heater layer) based on the results of detection of concentration of toxic impurities, and repeatedly performs the refreshing process through the control of the voltage applied to the heater unit 1010, high detection accuracy can be obtained over a long period of time.

In addition, the hydrogen impurity testing method of the present embodiment includes the threshold determination step of determining whether the change in the work function of the gate layer (metal electrode layer) exceeds a predetermined threshold value and the refresh step of heating the sensor unit with the heater unit when it is determined that the change in the work function of the gate layer (metal electrode layer) exceeds the predetermined threshold value in the threshold determination step. Since the sensor unit 1001 is refreshed by repeating each of the steps, the sensor unit 1001 can be maintained in good condition.

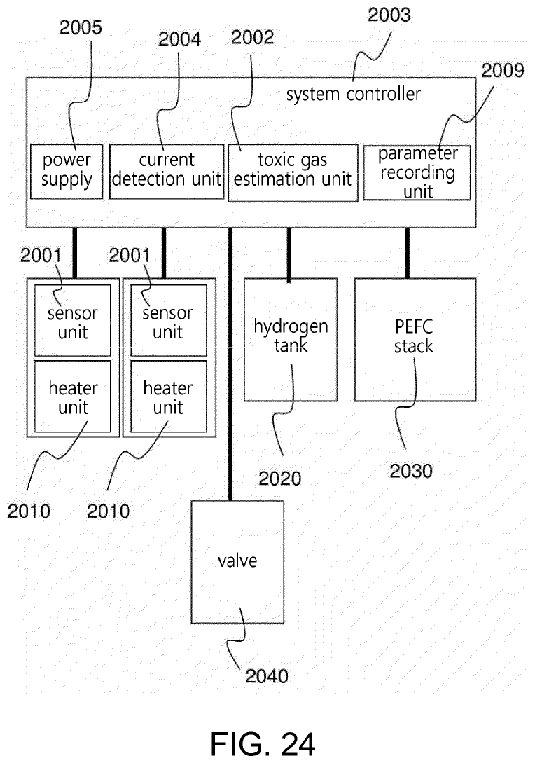

Next, a hydrogen impurity testing system and a hydrogen impurity testing method according to second and third embodiments of the present invention will be described with reference to FIGS. 24 through 34.

### Second Embodiment

FIG. 24 illustrates an example of a hydrogen impurity testing system as a second embodiment.

A sensor unit 2001 and a heater unit 2010 that are constructed in the same manner as in the first embodiment shown in FIG. 1 are connected to a system controller 2003. Although not illustrated in the figures, the system controller 2003 includes elements that constitute the circuit unit shown in FIG. 1, such as a toxic gas concentration estimation unit 2002, a current detection unit 2004, a power supply 2005, a parameter recording unit 2009, and an I/O unit. The system controller 2003 controls the sensor unit 2001 and the heater unit 2010 themselves, a hydrogen tank 2020, a PEFC stack 2030, and a valve 2040 using information on the concentration of impurities in hydrogen measured using the sensor unit 2001 and heater unit 2010. The system controller 2003 includes a circuit to operate these devices. In addition, the conditions for controlling these devices are recorded in the parameter recording unit 2009 of the system controller 2003.

Herein below, the case where a FET-type sensor is used for the sensor unit will be described, but a capacitor-type sensor or a diode-type sensor can be used as well.

As disclosed in Non-Patent Document 1, FET-type sensors, capacitor-type sensors, and diode-type sensors are named work function gas sensors because they detect the gas concentration in the atmosphere according to changes in the work function.

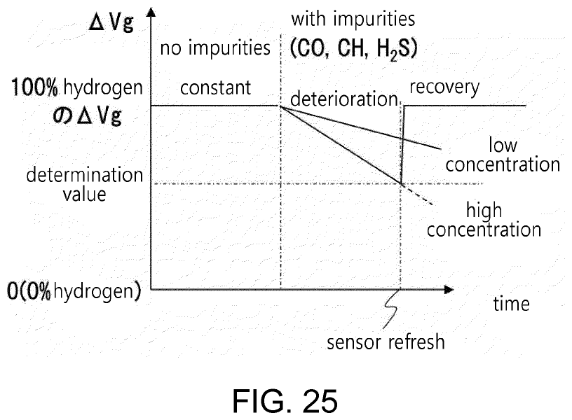

FIG. 25 is an explanatory view for a system in which the FET-type sensor is controlled by the system controller 2003.

A FET-type sensor that measures the concentration of toxic impurities in highly concentrated hydrogen (a concentration of almost 100%), continues to show ΔVg corresponding to 100% hydrogen concentration when the impurity concentration is 0. When toxic impurities are introduced into the hydrogen for some reason, ΔVg decreases because the adsorption sites of the gate layer of the sensor FET are occupied by the toxic impurities. The rate of decrease of ΔVg depends on the concentration of the toxic impurity in the hydrogen, and the higher the concentration of the toxic impurity, the more rapidly ΔVg decreases. The concentration of the toxic impurity from time to time can be estimated from the value of ΔVg and its time derivative.

When impurities that cause permanent poisoning, such as hydrogen sulfide, are included in the toxic impurities, the sensor FET will be permanently poisoned and become disabled if the poisoning continues at high concentrations. Therefore, it is necessary to perform a refreshing operation at appropriate timing to prevent permanent poisoning.

The parameter recording unit 2009 of the system controller 2003 records a determination value for the threshold voltage shift ΔVg, for example, to determine the timing for refreshing the sensor FET. When ΔVg decreases beyond the determination value, the system controller 2003 supplies power to the heater unit 2010 to heat the sensor unit 2001 using the Joule heat. That is, the refreshing operation is performed. Since ΔVg recovers by the refreshing operation, when toxic impurities are contained in the atmospheric hydrogen, ΔVg will decrease again. When ΔVg decreases beyond the determination value, the refreshing operation will be performed repeatedly.

In the example described above, the refresh timing is determined by comparing the measured ΔVg with the determination value recorded in the parameter recording unit 2009 of the system controller 2003. For example, the refresh timing is determined by estimating the toxic impurity concentration every moment from ΔVg and its time derivative and comparing the estimated impurity concentration with the impurity concentration determination value recorded in the parameter recording unit 2009 of the system controller 2003.

As described in connection with the first embodiment, since the sensor FET is formed of a semiconductor substrate and a metal oxide, the sensor FET has excellent heat resistance and can be refreshed at high temperatures, thereby having a longer sensor life than the case where PEFC sensors disclosed in Patent Documents 1 to 3 are used.

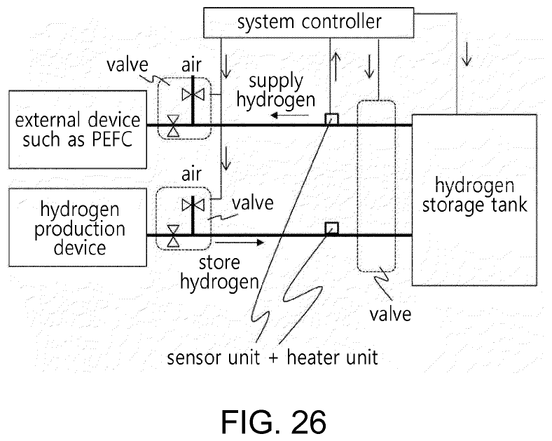

FIG. 26 is an explanatory view of a system in which the system controller 2003 controls hydrogen supply from a hydrogen production unit to the hydrogen storage tank and hydrogen supply from the hydrogen storage tank to an external device such as a PEFC using information on the concentration of impurities in hydrogen measured with the sensor unit 2001 and the heater unit 2010. In FIG. 26, the flow paths for supplying hydrogen from the hydrogen storage tank to the outside and from the outside to the hydrogen storage tank are formed separately, and each of the flow paths is provided with the sensor unit 2001 and the heater unit 2010.

In the case of high hydrogen concentration of almost 100%, the sensor unit 2001 continues to indicate ΔVg, which corresponds to 100% hydrogen concentration with an impurity concentration of zero. In this case, the system controller 2003 can control the opening and closing of valves based on information other than the impurity concentration in hydrogen, such as the hydrogen storage volume in the hydrogen storage tank, to control hydrogen storage in the hydrogen storage tank and hydrogen supply from the hydrogen storage tank to the outside.

When toxic impurities are introduced into hydrogen for some reason, ΔVg decreases because the adsorption sites in the gate layer of the sensor FET are occupied by the toxic impurities (FIG. 25). The rate of decrease of ΔVg depends on the concentration of the toxic impurities in the hydrogen, and the higher the concentration of toxic impurities, the more rapidly ΔVg decreases. The concentration of the toxic impurity from time to time can be estimated from the value of ΔVg and its time derivative.

For example, when the impurity concentration estimated by the sensor 2001 installed in the flow path for supplying hydrogen from the hydrogen storage tank to the outside is higher than the determination value recorded in the parameter recording unit 2009 of the system controller 2003, the valve in the flow path for supplying hydrogen from the hydrogen storage tank to the outside is closed and prevent low-quality hydrogen with a high impurity concentration from being supplied to external equipment.

Conversely, when the impurity concentration estimated by the sensor 2001 installed in the flow path for supplying hydrogen from the outside to the hydrogen storage tank is higher than the determination value recorded in the parameter recording unit 2009 of the system controller 2003, the valve in the flow path for supplying hydrogen from the outside to the hydrogen storage tank is closed and prevent low-quality hydrogen with a high impurity concentration from contaminating the hydrogen in the hydrogen storage tank.

As illustrated in FIG. 26, when the flow paths that supply hydrogen from the hydrogen storage tank to the outside and from the outside to the hydrogen storage tank are connected to the atmosphere via valves serving as gas exchange mechanisms, the flow paths connected to the hydrogen storage tank, external devices such as PEFCs, and hydrogen production equipment remain closed, and oxygen in the air can be diffused into the point where the sensor FET is installed. That is, the system controller 2003 controls the valves so that air (oxygen) can be diffused into the sensor FET to induce reaction between oxygen and the toxic impurities adsorbed on the adsorption sites of the gate layer (metal electrode layer) to refresh the sensor FET.

Even in the case where oxygen is used to refresh the sensor FET, the refreshing operation can be performed quickly if power is supplied to the heater layer and the sensor FET is heated by Joule heat. Therefore, combining the oxygen supply and the heating is effective for refreshing the sensor FET.

As described in the first embodiment and FIG. 26, since the sensor FET is formed of a semiconductor substrate and a metal oxide, the sensor FET has excellent heat resistance and can be refreshed at high temperatures, thereby having a longer sensor life than PEFC sensors disclosed in Patent Documents 1 to 3.

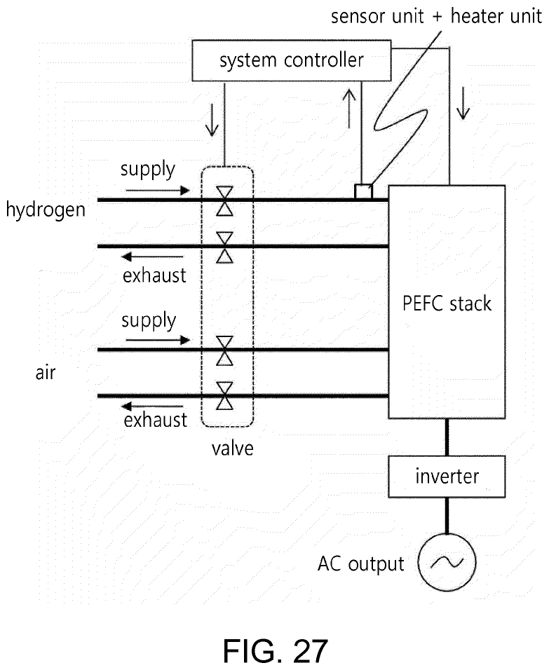

FIG. 27 is an explanatory diagram of a system in which the system controller 2003 controls the power generation of a PEFC stack using information on the concentration of impurities in hydrogen measured with the sensor unit 2001 and heater unit 2010.

Referring to FIG. 27, the sensor unit 2001 and the heater unit 2010 are installed on the flow path for supplying hydrogen to the PEFC stack. The PEFC stack generates electricity using the hydrogen supplied through the flow path and air supplied through an additional flow path. The electricity generated is fed externally via an inverter. The PEFC stack has a supply channel and an exhaust channel for each of hydrogen and air.

In the case of a high hydrogen concentration of almost 100%, the sensor unit 2001 continues to indicate ΔVg, which corresponds to a hydrogen concentration of 100% with an impurity concentration of zero (0). In this case, the system controller 2003 can control the valves on the basis of information other than the impurity concentration in hydrogen, such as external power demand, to control the amount of hydrogen supply to control the power generation in the PEFC stack.

When toxic impurities are introduced into the hydrogen for some reason, ΔVg decreases because the adsorption sites in the gate layer of the sensor FET are occupied by the toxic impurities (FIG. 25). The rate of decrease of ΔVg depends on the concentration of the toxic impurities in the hydrogen, and the higher the concentration of the toxic impurities, the more rapidly ΔVg decreases. The concentration of the toxic impurity from time to time can be estimated from the value of ΔVg and its time derivative.

For example, when the impurity concentration estimated by the sensor 2001 installed in the flow path is higher than the determination value recorded in the parameter recording unit 2009 of the system controller 2003, the system can be controlled to close the valve so that the power generation is stopped, and the deterioration of the PEFC stack is prevented.

The system control may be performed in a manner: when the impurity concentration is not high enough to immediately deteriorate the PEFC stack, the PEFC stack continues to operate; when the PEFC stack is deteriorated beyond a tolerance level, the PEFC stack is refreshed. In this case, the sensor unit 2001 installed in the flow path needs to estimate the cumulative damage to the PEFC stack caused by the toxic impurities.

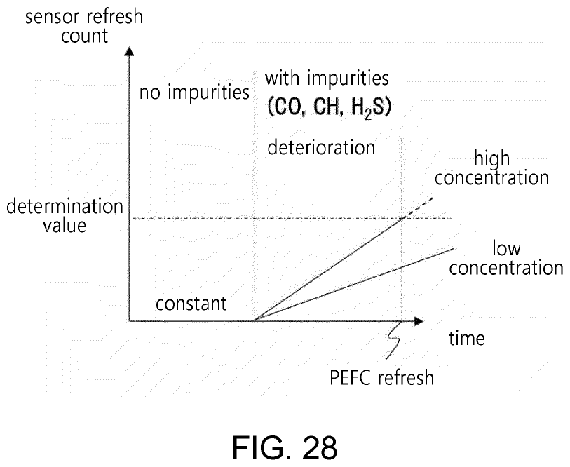

The sensor FET is formed by selecting the metal oxide material, gate layer material, and operating temperature, etc. Since the sensor FET is more sensitive to toxic impurities than PEFC stacks, the sensitivity of the sensor FET deteriorates earlier than the PEFCs. Therefore, the operation of refreshing the sensor FET can be repeated in the manner shown in FIG. 25, and the timing for refreshing the PEFC stack can be determined when the number of refreshing operations exceeds the set value recorded in the parameter recording unit 2009 of the system controller 2003, as shown in FIG. 28. Referring to FIG. 28, when the concentration of toxic impurities is high, the number of refreshing operations increases rapidly, so the timing for refreshing the PEFC stack becomes earlier.

When refreshing a PEFC stack, for example, air (oxygen) may be diffused from the cathode side to the anode side through the fuel cell membrane of the PEFC stack so that the oxygen may react with the toxic impurities, which makes the PEFC stack recover from poisoning. In this case, the system controller 2003 performs actions such as closing the valves on the hydrogen supply path and hydrogen disposal path and waiting for oxygen to diffuse to the anode side from the cathode side.

When the system controller 2003 performs this operation, oxygen in the air diffuses into the area where the sensor FET is installed, and the oxygen reacts with the toxic impurities adsorbed on the adsorption sites of the gate layer of the sensor FET. That is, the sensor FET is refreshed.

Even when oxygen is used to refresh the sensor FET, the refreshing operation can be performed quickly if power is supplied to the heater layer and the sensor FET is heated by Joule heat. Therefore, the sensor FET refreshing effect is enhanced by combining the oxygen supply and the heating.

### <Multistep Refreshing>

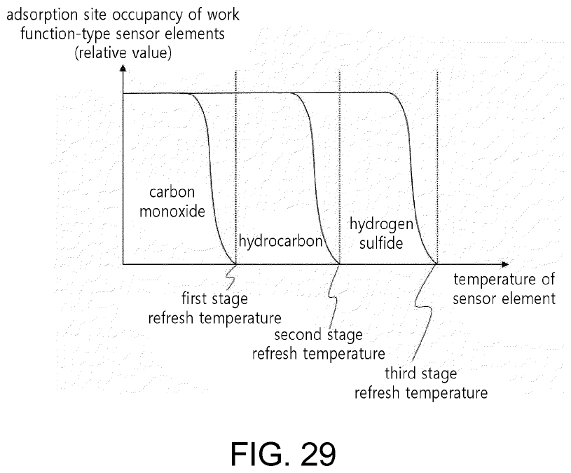

FIG. 29 illustrates multistep refreshing used in the hydrogen impurity testing system of the second embodiment.

As shown in FIG. 25, the toxic impurities adsorbed on the adsorption sites of the gate layer of the sensor FET can be collectively desorbed and flushed during the refresh process. Alternatively, the refreshing process can be performed in multiple stages using a first stage refresh temperature, a second stage refresh temperature, and a third stage refresh temperature as shown in FIG. 29. By measuring the threshold voltage shift ΔVg after the refreshing operation at each refresh temperature, it is possible to estimate how much of the adsorbed toxic impurities in the gate layer have been desorbed.

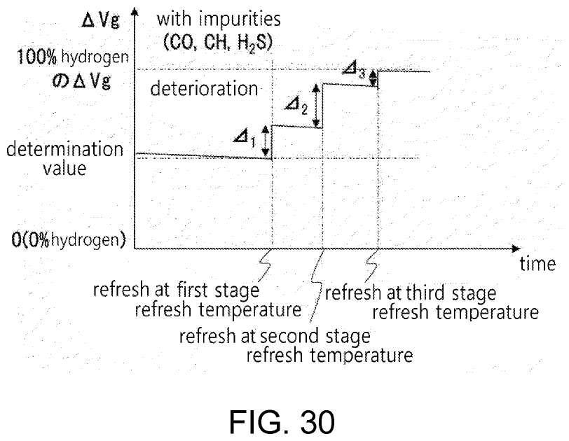

Changes in ΔVg due to refreshing at the three temperatures indicated in FIG. 29 are shown in FIG. 30.

At the first stage refresh temperature, carbon monoxide is desorbed from the gate layer of the sensor FET, and ΔVg recovers by Δ1. At the second stage refresh temperature, hydrocarbons are desorbed from the gate layer of the sensor FET, and ΔVg recovers by Δ2. At the third stage refresh temperature, hydrogen sulfide is desorbed from the gate layer of the sensor FET, and ΔVg recovers by Δ3. As a result, the ratio of carbon monoxide, hydrocarbons, and hydrogen sulfide adsorbed on the adsorption sites of the gate layer of the sensor FET can be estimated from the values of Δ₁, Δ₂, and Δ₃.

Furthermore, the concentrations of carbon monoxide, hydrocarbons, and hydrogen sulfide in the hydrogen can be estimated from the ratio. When the types of toxic impurities in the hydrogen can be estimated, the impact of the toxic impurities on the PEFC stack and other components that use the hydrogen can be predicted. In particular, the concentration of hydrogen sulfide, which causes permanent poisoning, is important from the perspective of protecting PEFCs.

In FIGS. 29 and 30, multistep refreshing is performed by changing the temperature step by step. Alternatively, the multistep refreshing can also be performed by changing the concentration of oxygen supplied to the sensor FET step by step. When the temperature is constant, the type of toxic impurity desorbed from the gate layer of the sensor FET differs according to the concentration of oxygen.

Just as the first stage refresh temperature, second stage refresh temperature, and third stage refresh temperature are used in FIG. 29, the first stage refresh oxygen concentration, second stage refresh oxygen concentration, and third stage refresh oxygen concentration can be used to perform multistep refreshing.

As a result, as in FIG. 30, ΔVg recovers only by Δ₁ at the first stage refresh oxygen concentration, ΔVg recovers only by Δ₂ at the second stage refresh oxygen concentration, ΔVg recovers only by Δ₃ at the third stage refresh oxygen concentration, and so on. The ratio of carbon monoxide, hydrocarbons, and hydrogen sulfide adsorbed on the adsorption sites of the gate layer of the sensor FET can be estimated from the values of Δ₁, Δ₂, and Δ₃.

Furthermore, the concentrations of carbon monoxide, hydrocarbons, and hydrogen sulfide in the hydrogen can be estimated from the ratio. Once the types of toxic impurities in the hydrogen can be estimated, the impact of the toxic impurities on the PEFC stack and other components that use the hydrogen can be predicted. In particular, the concentration of hydrogen sulfide, which causes permanent poisoning, is important from the perspective of protecting PEFCs.

In addition to the multistep refreshment changing the temperature of the sensor FET in stepwise and the multistep refreshment changing the concentration of oxygen supplied to the sensor FET in stepwise, the multistep refreshment can also be performed by changing both the temperature of the sensor FET and the concentration of oxygen supplied to the sensor FET in stepwise.

### Second Embodiment 2: Effect

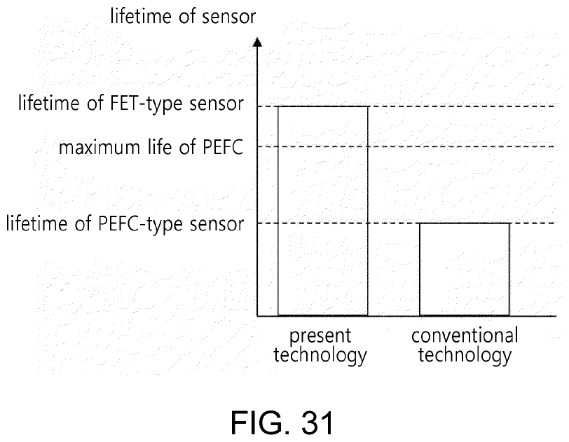

FIG. 31 is a view illustrating comparison in the lifetime of PEFC stacks between the hydrogen impurity testing system of the second embodiment and a hydrogen impurity testing system using a PEFC sensor, when the methods shown in FIGS. 27 to 30 are used.

The FET-type sensor has a longer lifetime than the PEFC sensor as well as the PEFC stack.

On the other hand, the PEFC sensor has a shorter lifetime than the PEFC stack when it is more sensitive to toxic impurities than the PEFC stack. Therefore, while the hydrogen impurity testing system of the second embodiment can protect the PEFC stack by constantly measuring the concentration of toxic impurities during the lifetime of the PEFC stack, the PEFC sensor becomes unusable and cannot protect the PEFC stack before the lifetime of the PEFC stack ends. The PEFC stack that cannot be no longer protected is rapidly deteriorated by the toxic impurities.

As described above, the hydrogen impurity testing system of the second embodiment is equipped with a gas exchange mechanism capable of temporarily introducing air containing oxygen into the atmosphere, and the system controller 2003 has a function of controlling the gas exchange mechanism to supply air to the gate layer (metal electrode layer).

In other words, in the hydrogen impurity testing system, the refreshing can be performed by reacting the toxic impurities adsorbed on the gate layer (metal electrode layer) with oxygen in the air.

In addition, in the hydrogen impurity testing system of the second embodiment, when controlling the gas exchange mechanism, the system controller increases the concentration of oxygen in the air supplied to the gate layer (metal electrode layer) in multiple steps and has a function of separating the components of toxic impurities from correspondence between the concentration of oxygen and the refreshed amount of work function change due to the toxic impurities.

In other words, the hydrogen impurity testing system can separate and desorb toxic impurities even though multiple toxic impurities are adsorbed, and can detect the concentration of each toxic impurity separately.

### Third Embodiment

In a third embodiment, a method of testing hydrogen for impurities using the hydrogen impurity testing system of the first embodiment and the hydrogen impurity testing system of the second embodiment will be described.

In an example described below, a FET-type sensor is used in a sensor unit 2001. However, a capacitor-type sensor or a diode-type sensor can be used as well. As described in Non-Patent Document 1, FET-type sensors, capacitor-type sensors, and diode-type sensors are named work function type gas sensors because they detect gas concentration in the atmosphere according to change in the work function.

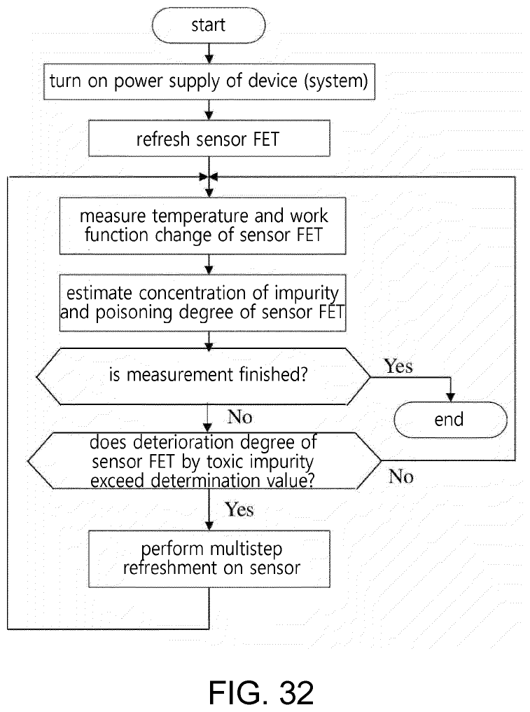

FIG. 32 illustrates an example of the flow of a hydrogen impurity testing method.

First, the power of the hydrogen impurity testing system is turned on. Next, the sensor FET is refreshed. Since toxic impurities may be adsorbed on the gate layer of the sensor FET while the power is not turned on, it is preferable to refresh the sensor FET before starting the measurement of toxic impurities in hydrogen. After the refreshing operation, the electric current flowing to the heater layer is controlled so that the temperature of the sensor unit is adjusted to be suitable for measuring the concentration of toxic impurities in hydrogen.

Next, the temperature and work function of the sensor FET are measured, and the results are used to estimate the concentration of impurities in hydrogen and the degree of poisoning of the sensor FET. When there is an instruction to terminate the measurement, the termination process is performed; otherwise, it is determined whether the deterioration of the sensor FET due to poisoning exceeds the determination value recorded in the parameter recording unit 2009.

When the determination value is not exceeded, the temperature of the sensor FET and the work function change are measured again. When the determination value is exceeded, the sensor is refreshed. In this case, all the toxic impurities adsorbed on the adsorption sites of the gate layer of the sensor FET can be collectively desorbed. Alternatively, by the multistep refreshing shown in FIGS. 29 and 30, the types of toxic impurities adsorbed on the adsorption sites of the gate layer of the sensor FET can be estimated. After the refreshing, the temperature and work function change of the sensor FET are measured again as if the refresh had not been performed.

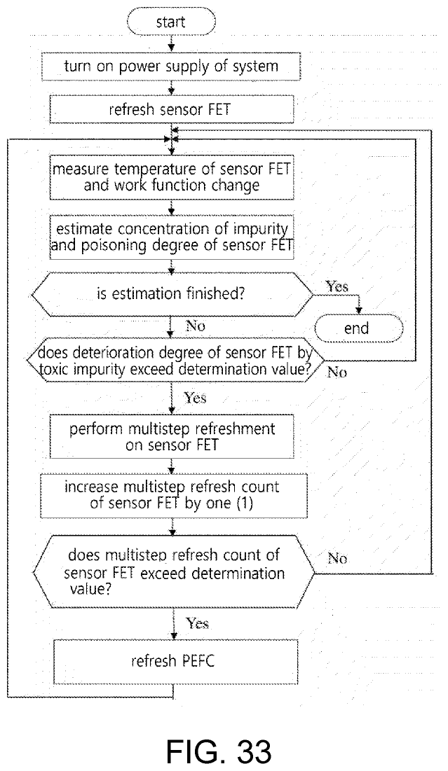

FIG. 33 illustrates an example of the flow of a hydrogen impurity testing method of a hydrogen impurity testing system including a PEFC stack.

First, the power of the hydrogen impurity testing system is turned on. Next, the sensor FET is refreshed. Since toxic impurities may be adsorbed on the gate layer of the sensor FET while the power is not turned on, it is preferable to refresh the sensor FET before starting the measurement of toxic impurities in hydrogen. After the refreshing operation, the electric current flowing to the heating layer is controlled to adjust the temperature of the sensor unit to be suitable for measuring the concentration of toxic impurities in hydrogen.

Next, the temperature and work function of the sensor FET are measured, and the results are used to estimate the concentration of impurities in hydrogen and the degree of poisoning of the sensor FET. When there is an instruction to terminate the measurement, the termination process is performed; otherwise, it is determined whether the deterioration of the sensor FET due to poisoning exceeds the determination value recorded in the parameter recording unit 2009.

When the determination value is not exceeded, the temperature of the sensor FET and the work function change are measured again. When the determination value is exceeded, the sensor is refreshed. In this case, all the toxic impurities adsorbed on the adsorption sites of the gate layer of the sensor FET can be desorbed together, but by performing the multistep refreshing shown in FIGS. 29 and 30, the types of toxic impurities adsorbed on the adsorption sites of the gate layer of the sensor FET can be estimated. After the refreshing is performed, a multistep refresh count which means the number of times the sensor FET underwent multistep refreshing is increased by 1. The multistep refresh count is recorded in the parameter recording unit 2009, which is a component of the system controller.

Next, the system determines whether the multistep refresh count of the sensor FET exceeds the determination value recorded in the parameter recording unit 2009 of the system controller. If the determination value is not exceeded, the temperature and work function change of the sensor FET are measured again. When the determination value is exceeded, the PEFC stack is refreshed. After the PEFC stack is refreshed, the temperature and work function change of the sensor FETs are measured again.

### Third Embodiment: Effect

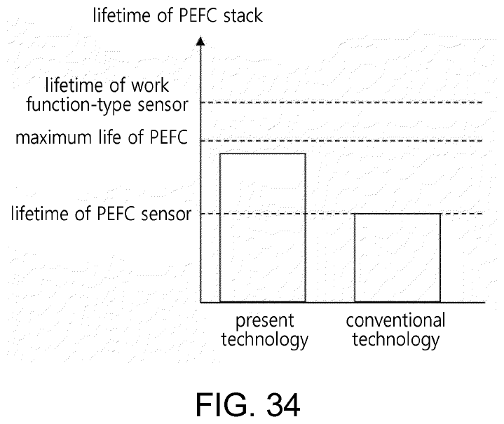

FIG. 34 is a view illustrating comparison between the lifespan of a PEFC stack when using the hydrogen impurity testing method of FIG. 33 and the lifespan of a PEFC stack when using a conventional PEFC sensor.

While the lifetime of the PEFC stack is limited by the lifetime of the PEFC sensor in conventional technology, the present technology can increase the lifetime of the PEFC stack to near the maximum lifetime of the PEFC stack.

Thus, in the hydrogen impurity testing system of the present embodiment, the system controller has a fuel cell refresh function that performs a fuel cell refresh to desorb toxic impurities adsorbed on the PEFC stack (polymer electrolyte fuel cell) when it is determined by the threshold number determination function that the threshold count value is exceeded. Therefore, the PEFC stack (polymer electrolyte fuel cell) is refreshed according to the number of times the sensor unit has been refreshed, resulting in the extension of the lifespan of the PEFC stack.

### About a Modification of the Invention

The present invention is not limited to the embodiments described above, but includes various modifications. For example, the embodiments described are described in detail for the purpose of explaining the invention in an easy-to-understand manner, and are not necessarily limited to those having all the described configurations. It is also possible to replace some configurations of one embodiment with configuration of another embodiment, and it is also possible to add configurations of one embodiment to the configurations of another embodiment. It is also possible to add, delete, or replace some of the configurations of each embodiment with other configurations.

What is claimed is:

1. A hydrogen impurity testing system comprising:
a sensor unit installed in an atmosphere with highly concentrated hydrogen containing toxic impurities;
a heater unit capable of heating the sensor unit;
a system controller applying a voltage to the sensor unit to measure a flowing electric current and controlling at least the sensor unit and the heater unit;
wherein the heater unit comprises
a semiconductor substrate,
an impurity layer of a first conductivity type formed on a surface of the semiconductor substrate,
a metal oxide layer formed on the surface of the semiconductor substrate, and
a metal electrode layer, which is made of a metal having adsorption sites for hydrogen and toxic impurities, formed on the metal oxide layer and exposed to the atmosphere to be able to adsorb the toxic impurities, and
the system controller detects a concentration of the toxic impurities by measuring change in work function of the metal electrode layer according to type and concentration of the toxic impurities and, based on results of detection, performs a refresh by heating the metal electrode layer with the heater unit to desorb the toxic impurities adsorbed on the metal electrode layer.

2. The hydrogen impurity testing system according to claim 1, wherein the heater unit is capable of heating the sensor unit using a temperature increase by Joule heat generated by applying a voltage to make an electric current flow, and
the system controller controls a voltage applied to the heater unit based on results of detection of concentration of the toxic impurities to perform the refresh.

3. The hydrogen impurity testing system according to claim 2, wherein the system controller, when performing the refresh, has a function of increasing temperature of the sensor unit in multiple steps to separate components of the toxic impurities from correspondence between temperature of the sensor unit and amount of refresh of change in work function change by the toxic impurities.

4. The hydrogen impurity testing system according to claim 2, further comprising a gas exchange mechanism capable of temporarily introducing air containing oxygen into the atmosphere,
wherein the system controller has a function of controlling the gas exchange mechanism to supply air to the metal electrode layer.

5. The hydrogen impurity testing system according to claim 3, further comprising a gas exchange mechanism capable of temporarily introducing air containing oxygen into the atmosphere,
wherein the system controller has a function of controlling the gas exchange mechanism to supply air to the metal electrode layer.

6. The hydrogen impurity testing system according to claim 4, the system controller, wherein when controlling the gas exchange mechanism, has a function of increasing concentration of oxygen in air supplied to the metal electrode layer in multiple steps to separate components of the toxic impurities from correspondence between concentration of oxygen and amount of refresh of change in work function by the toxic impurities.

7. The hydrogen impurity testing system according to claim 5, the system controller, wherein when controlling the gas exchange mechanism, has a function of increasing concentration of oxygen in air supplied to the metal electrode layer in multiple steps to separate components of the toxic impurities from correspondence between concentration of oxygen and amount of refresh of change in work function by the toxic impurities.

8. The hydrogen impurity testing system according to claim 1, wherein the highly concentrated hydrogen is hydrogen supplied to a polymer electrolyte fuel cell and
the system controller has a refresh count recording function that records a refresh count of performed refreshes of the sensor unit, a threshold count determination function that determines whether the refresh count exceeds a predetermined threshold count value, and a fuel cell refresh function that performs a refresh of a fuel cell that desorbs the toxic impurities adsorbed on the polymer electrolyte fuel cell when the refresh count is determined to be exceeded by the threshold count determination function.

9. The hydrogen impurity testing system according to claim 2, wherein the highly concentrated hydrogen is hydrogen supplied to a polymer electrolyte fuel cell and
the system controller has a refresh count recording function that records a refresh count of performed refreshes of the sensor unit, a threshold count determination function that determines whether the refresh count exceeds a predetermined threshold count value, and a fuel cell refresh function that performs a refresh of a fuel cell that desorbs the toxic impurities adsorbed on the polymer electrolyte fuel cell when the refresh count is determined to be exceeded by the threshold count determination function.

10. A hydrogen impurity testing method using the hydrogen impurity testing system according to claim 1, the method comprising:
a work function change measurement step that measures change in work function of the metal electrode layer;
a concentration measurement step that measures concentration of the toxic impurities,
a threshold determination step that determines whether change in work function of the metal electrode layer exceeds a predetermined threshold value, and
a refresh step in which the sensor unit is heated by the heater unit in case the predetermined threshold value is determined to be exceeded in the threshold determination step.

11. The method according to claim 10, wherein the highly concentrated of hydrogen is hydrogen supplied to a polymer electrolyte fuel cell and
the method further comprises:
a refresh count recording step that records a refresh count of performed refreshes of the sensor unit by the hydrogen impurity testing system;
a threshold count determination step that determines whether the refresh count exceeds a predetermined threshold count value; and
a fuel cell refresh step that performs a fuel cell refresh that desorbs the toxic impurities adsorbed on the polymer electrolyte fuel cell in case the predetermined threshold count value is determined to be exceeded in the threshold count determination step.
